(19) United States
(12) Patent Application Publication
(10) Pub. No.: US 2026/0217519 A1
(43) Pub. Date: Jul. 30, 2026

(54) WATER DISPENSING DEVICE

(71) Applicant: LG ELECTRONICS INC., Seoul (KR)

(72) Inventor: Shic YOON, Seoul (KR)

(21) Appl. No.: 19/142,433

(22) PCT Filed: Nov. 2, 2023
(86) PCT No.: PCT/KR2023/017355

§ 371 Date: Jun. 23, 2025

(30) Foreign Application Priority Data
Dec. 27, 2022 (KR) 10-2022-0185218
Sep. 15, 2023 (KR) 10-2023-0123046

(51) Int. Cl. B67D 1/07; B67D 1/00; B67D 1/12

(52) U.S. Cl. CPC B67D 1/07; B67D 1/1277; B67D 2001/0093; B67D 2001/0095; B67D 2001/075

(57) ABSTRACT

The present invention relates to a water dispensing device and, more specifically, to a water dispensing device provided in a water purifier. The water dispensing device according to one embodiment may comprise: a water dispensing unit for dispensing water; a body having a space therein so as to accommodate the water dispensing unit; a driving unit for moving the water dispensing unit; a shaft for guiding the movement of the body; and an upper cover provided so as to move relative to the shaft.

### TECHNICAL FIELD

The present disclosure relates to a water dispensing apparatus, and more specifically, to a water dispensing apparatus disposed in a water purifier.

### BACKGROUND ART

Content described in this section simply provides background information for the present disclosure and does not constitute prior art.

A water purifier is an apparatus that filters raw tap water to remove impurities therefrom. The water purifier removes floating substances, harmful substances, or the like contained in tap water using a filter, and purifies and dispenses a desired amount of water based on manipulation of a user. Recent water purifiers are able to dispense hot and cold water as well as purify water, are small in size, and are able to be installed in various environments.

Prior arts related thereto are disclosed in Korean Patent No. 10-2068226 (prior art 1), Korean Patent Application Publication No. 10-2020-0058131 (prior art 2), and Korean Patent Application Publication No. 10-2019-0118840 (prior art 3).

The water purifier is equipped with a water dispensing apparatus that discharges water for the user to drink. A water dispenser that discharges water is equipped in the water dispensing apparatus.

A cup that receives water from the water purifier varies in size. Therefore, the water dispenser needs to be positioned such that a distal end thereof corresponds appropriately to a vertical level of an upper end of each cup so that water is contained in the cup smoothly and quietly without splashing, considering the size of the cup, that is, the vertical level of the upper end of the cup.

To this end, the water dispenser may be equipped to move in a vertical direction of the water purifier. Such a movement of the water dispenser may be implemented by a driving apparatus equipped in the water dispensing apparatus and including a motor or the like.

The water dispenser may be equipped with a valve that controls the dispensing of water. Water discharged from the water dispenser may be cold water or hot water based on a set temperature. A location of such a valve may affect the temperature of cold water or hot water.

When the valve is positioned far from the distal end of the water dispenser where water is discharged to the outside, water that has passed through the valve may undergo heat transfer with outside air before being discharged to the outside, causing the temperature of cold water to rise and the temperature of hot water to drop.

Therefore, for dispensed cold water or hot water to be discharged into the cup while maintaining the set temperature, it may be advantageous to have a smaller distance between the valve and the distal end of the water dispenser.

The valve that controls the water dispensing may have a considerable volume. In addition, the driving apparatus that controls the movement of the water dispenser may also have a considerable volume.

When placing valve and the driving apparatus in the water dispensing apparatus, the valve needs to be disposed close to the distal end of the water dispenser, so that it is necessary to design a water dispensing apparatus that places the water dispenser and the driving apparatus, which occupy the considerable volumes, at appropriate locations.

In one example, when moving the water dispenser in the vertical direction, a structure that may appropriately guide the movement of the water dispenser and enable smooth movement of the water dispenser is required.

In addition, when moving the water dispenser in the vertical direction, a structure that may determine a movement range of the water dispenser and limit excessive descent of the water dispenser is required.

### SUMMARY OF DISCLOSURE

### Technical Purpose

The present disclosure is to provide a water dispensing apparatus having a structure in which a valve and a driving apparatus are appropriately arranged such that discharged water maintains a set temperature.

In addition, the present disclosure is to provide a water dispensing apparatus having a structure in which a movement in a vertical direction of a water dispenser with respect to a water purifier is guided, so that the water dispenser may move smoothly and stably.

In addition, the present disclosure is to provide a water dispensing apparatus having a structure in which, when a water dispenser moves in a vertical direction, a movement rage of the water dispenser may be determined and excessive descending of the water dispenser may be restricted.

Purposes of the present disclosure are not limited to the purposes mentioned above, and other purposes and advantages of the present disclosure that are not mentioned may be understood by a following description and will be more clearly understood by the embodiments of the present disclosure. In addition, it will be easily understood that the purposes and advantages of the present disclosure may be realized by the means and combinations thereof indicated in the patent claims.

### Technical Solution

A water dispensing apparatus according to an embodiment may be equipped in a water purifier. An embodiment of the water dispensing apparatus may include a water dispenser that discharges water for a user to drink, a body that accommodates the water dispenser therein, and a driver that moves the water dispenser. The water dispenser may be disposed inside the body, and the driver may be disposed outside the body.

The water dispensing apparatus may include a sterilizer for sterilizing drinking water, and the sterilizer may include a second nozzle that discharges water for the user to drink to the outside. The water dispenser may be equipped with a control valve that controls opening and closing of a water inlet, a drainage, and a first nozzle. The water dispenser and the sterilizer may be connected to each other and arranged adjacent to each other.

Therefore, the control valve equipped in the water dispenser and the second nozzle equipped in the sterilizer may be arranged adjacent to each other. In addition, the control valve and a distal end of the second nozzle are not connected to each other by a separate additional pipe, so that a distance therebetween is very small.

The water dispensing apparatus may include a second substrate that is positioned in a lower portion of the body and irradiates an ultrasonic wave toward a cup positioned below the water dispensing apparatus. The second substrate may include at least one ultrasonic transmitter and at least one ultrasonic receiver.

The second substrate may use the ultrasonic wave to accurately identify a location of an upper end of the cup, and accordingly, a controller equipped in the water purifier may appropriately adjust a distance between a lower end of the second nozzle and the upper end of the cup based on information transmitted from the second substrate.

The water dispensing apparatus may be equipped with a stopper movably disposed on a lower cover, and a photo sensor that stops a movement of the body when the stopper moves upward and blocks a photo detector.

The stopper may ascend when it comes into contact with the upper end of the cup and block the photo sensor, and accordingly, the photo sensor may transmit an abnormality signal to the controller, so that the controller may stop the operation of the driver.

A water dispensing apparatus of an embodiment may include a water dispenser that discharges water, a body having a space defined inside to accommodate the water dispenser therein, a driver that moves the water dispenser, a shaft that guides a movement of the body, and an upper cover movable relative to the shaft.

The water dispenser may include a water inlet constructed to receive water introduced thereinto, a drainage connected to the water inlet and constructed to discharge water introduced into the water inlet to the outside, a first nozzle connected to the water inlet and constructed to discharge water therethrough, and a control valve that controls opening and closing of the water inlet, the drainage, and the first nozzle.

The water dispenser may include a first mounting portion extending from the control valve and mounting the water dispenser in the body, and the first mounting portion may include a first cell protruding from the control valve, and a second cell extending from the first cell and having a longitudinal direction parallel to a longitudinal direction of the body.

The body may include a first part protruding inwardly of the body and in contact with one surface of the second cell, and a second part disposed to be spaced apart from the first part and in contact with a surface opposite to the one surface of the second cell.

The upper cover may include a second mounting portion for mounting the water dispenser in the body, and the second mounting portion may include a first piece, and a first hook disposed at an end of the first piece and coupled to respective ends of the second cell and the second part.

The first hook may have both side edges protruding to define a coupling groove therebetween, and the respective ends of the second cell and the second part may be inserted into the coupling groove.

The water dispensing apparatus may further include a light-emitter disposed in a lower portion of the body, a second substrate that is disposed to be surrounded by the light-emitter and irradiates an ultrasonic wave, and a lower cover allowing the light-emitter and the second substrate to be seated thereon, and mounted at a lower end of the body.

The light-emitter may include a third substrate equipped with a light source that irradiates visible light, a light diffuser connected to the light source equipped on the third substrate and formed in a ring shape, and a light ring having the light diffuser disposed therein, and mounted in the body, wherein the light ring outwardly irradiates light incident thereon after passing through the light diffuser.

The light ring may include a seating ring protruding from an inner surface of the light ring and allowing the light diffuser to be seated thereon, and a first mounting protrusion protruding from the inner surface of the light ring and positioned above the seating ring, wherein the first mounting protrusion mounts the light diffuser on the seating ring.

The lower cover may include a second mounting protrusion protruding from an inner surface of the lower cover and allowing the light ring to be mounted thereon, and the light ring may include a first mounting groove where the second mounting protrusion is mounted at a location corresponding to the second mounting protrusion.

The lower cover may include a first hole defined in a center of the lower cover, and a plurality of second holes defined to surround the first hole and allowing the ultrasonic wave irradiated from the second substrate to pass therethrough.

The second substrate may include at least one ultrasonic transmitter disposed at a location corresponding to at least one of the plurality of second holes, and at least one ultrasonic receiver disposed at a location corresponding to a remainder of the plurality of second holes, excluding the at least one of the plurality of second holes where the ultrasonic transmitter is disposed.

The water dispensing apparatus may further include a stopper movably disposed on the lower cover, and a photo sensor that stops the movement of the body when the stopper moves upward and blocks a photo detector.

The photo sensor may include a third mounting portion having a through-hole defined therein and mounted on the light ring, and the photo detector formed integrally with the third mounting portion and having a concave groove defined therein, wherein the photo detector senses light.

The stopper may include a contact sensor that protrudes outwardly of the lower cover and senses contact with a container for containing water, and a protruding portion formed integrally with the contact sensor, and positioned in the concave groove to suppress the photo detector from sensing light when the container comes into contact with the contact sensor and the stopper moves upward.

The lower cover may include a first mounting structure where the stopper is mounted so as to be movable relative to the lower cover, and the light ring may include a pin-to-be-inserted inserted into the through-hole and a second mounting structure where the third mounting portion is mounted.

The lower cover may include a fifth fastener coupling a sterilizer mounted on the water dispenser to the lower cover.

The body may include a third mounting protrusion protruding from an inner surface of the body and mounting the light ring in the body, and the light ring may include a second mounting groove formed by recessing an outer surface of the light ring and allowing the third mounting protrusion to be mounted therein.

The water dispensing apparatus may further include an extension mounted in the first hole, disposed to surround a water dispensing portion of the water dispenser, and having at least a portion thereof protruding downwardly of the lower cover.

### Technical Effect

In the water dispensing apparatus according to the present disclosure, the volume of the body may be significantly reduced by placing the water dispenser inside the body and placing the driver that moves the body and the water dispenser in the vertical direction outside the body.

In addition, in the water dispensing apparatus according to the present disclosure, the control valve disposed in the water dispenser and the second nozzle disposed in the sterilizer may be arranged at the adjacent locations. In addition, the control valve and the distal end of the second nozzle are not connected to each other by the separate additional pipe, so that the distance therebetween is very small.

Therefore, because there is almost no heat transfer with outside air between the control valve and the distal end of the second nozzle, the heating of cold water or the cooling of hot water may be effectively suppressed. As a result, water that has passed through the control valve may be discharged to the outside via the second nozzle while maintaining the set temperature, thereby providing the convenience to the user.

In addition, in the water dispensing apparatus according to the present disclosure, the first mounting portion may be disposed in the water dispenser, and the first mounting portion may be mounted by sliding in the gap between the first part and the second part of the body or may be removed from such a gap. In addition, the upper cover may have the second mounting portion to prevent the second cell of the first mounting portion from moving upward and being easily removed from the body.

Because of such a structure, the water dispenser may be easily detachable from the body, so that the assembly and the disassembly of the water dispensing apparatus may be facilitated.

In addition, in the water dispensing apparatus according to the present disclosure, the water dispensing apparatus may have the second substrate that transmits and receives the ultrasonic wave to accurately identify the location of the upper end of the cup, and accordingly, the controller may appropriately adjust the distance between the lower end of the second nozzle and the upper end of the cup.

Accordingly, water discharged from the second nozzle may be filled into the cup quietly without splashing, thereby providing the convenience to the user.

In addition, in the water dispensing apparatus according to the present disclosure, the stopper and the photo sensor are equipped, the stopper ascends and blocks the photo sensor when coming into contact with the upper end of the cup, and accordingly, the photo sensor transmits the abnormality signal to the controller, so that the controller may stop the operation of the driver.

Accordingly, the cup or the water dispensing apparatus may be effectively prevented from being damaged because of the excessive descending of the body and the lower cover.

In addition to the above-described effects, specific effects of the present disclosure will be described together with the specific matters for carrying out the invention below.

### BRIEF DESCRIPTION OF DRAWINGS

FIG. 1 is a schematic diagram of a water purifier according to an embodiment.

FIG. 2 is an exploded view of a water dispensing apparatus according to an embodiment.

FIG. 3 is a perspective view of a water dispensing apparatus according to an embodiment.

FIG. 4 is a perspective view showing a descended state of a body in FIG. 3.

FIG. 5 is a diagram showing a water dispenser according to an embodiment.

FIG. 6 is a diagram showing an upper cover according to an embodiment.

FIG. 7 is a cross-sectional view of some components of a water dispensing apparatus.

FIG. 8 is a diagram of some components of a water dispensing apparatus.

FIG. 9 is a perspective view of some components of a water dispensing apparatus.

FIG. 10 is a perspective view showing a state in which a third substrate and a light ring are coupled to each other.

FIG. 11 is a plan view of FIG. 10.

FIG. 12 is a perspective view showing a cross-section of a body.

FIG. 13 is a perspective view showing a lower cover.

FIG. 14 is a plan view of FIG. 13.

FIG. 15 is a diagram showing a state in which a lower cover is mounted on a body.

FIG. 16 is a diagram showing a state in which a stopper is mounted in a lower cover.

FIG. 17 is a diagram showing a state in which a stopper in FIG. 16 has ascended.

FIG. 18 is a diagram showing a state in which a photo sensor is coupled to a light-emitter.

FIG. 19 is a cross-sectional view showing a direction 12-12 in FIG. 3.

FIG. 20 is an enlarged view showing a portion 11 in FIG. 12.

FIG. 21 is a diagram showing a state in which a driver and a base are coupled to each other.

FIG. 22 is a diagram of FIG. 21 viewed from a different direction.

FIG. 23 is a diagram showing a state in which a body and an upper cover are coupled to each other.

FIG. 24 is a diagram showing a sterilizer according to an embodiment.

FIG. 25 is an exploded view showing a sterilizer according to an embodiment.

FIG. 26 is a cross-sectional view showing a sterilizer and a body coupled to each other.

FIGS. 27 and 28 are diagrams showing the prior art 1.

### DETAILED DESCRIPTIONS

The above-mentioned purposes, features, and advantages will be described in detail later with reference to the attached drawings, so that those skilled in the art in the technical field to which the present disclosure belongs may easily practice the technical ideas of the present disclosure. In describing the present disclosure, when it is determined that a detailed description of the publicly known technology related to the present disclosure may unnecessarily obscure the gist of the present disclosure, the detailed description thereof will be omitted. Hereinafter, a preferred embodiment according to the present disclosure will be described in detail with reference to the attached drawings. In the drawings, identical reference numerals are used to indicate identical or similar components.

Although first, second, and the like are used to describe various components, these components are not limited by such terms. Such terms are only used to distinguish one component from another component, and unless specifically stated to the contrary, a first component may also be a second component.

Throughout the present document, unless otherwise stated, each component may be singular or plural.

As used herein, singular expressions include plural expressions, unless the context clearly dictates otherwise. In the present application, terms such as “composed of” or “include” should not be construed as necessarily including all of various components or steps described herein, and should be interpreted as being able to not including some of the components or the steps and further including additional components or steps.

Throughout the present disclosure, “A and/or B” means A, B, or A and B, unless otherwise specified, and “C to D” means C inclusive to D inclusive unless otherwise specified.

Throughout the present document, a “vertical direction” means a vertical direction of a water purifier and a water dispensing apparatus 100 in a state in which the water purifier is installed for daily use. A “left and right direction” means a direction orthogonal to the vertical direction, and a front and rear direction means a direction orthogonal to both the vertical direction and the left and right direction. A “bilateral direction” or a “lateral direction” has a meaning including the left and right direction and the front and rear direction.

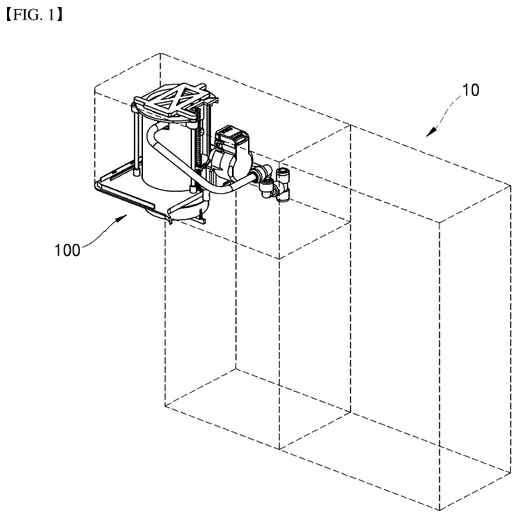

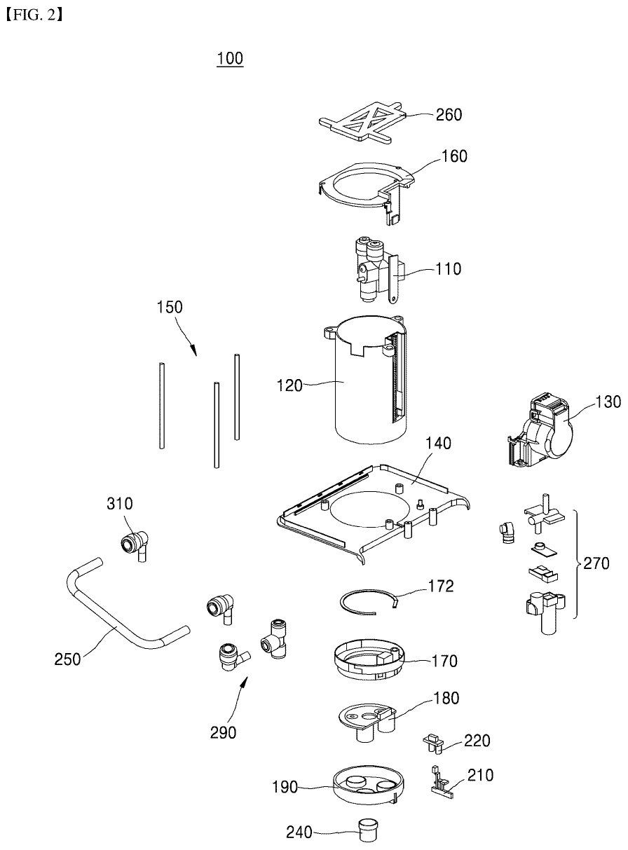

FIG. 1 is a schematic diagram of the water purifier according to an embodiment. FIG. 2 is an exploded view of the water dispensing apparatus 100 according to an embodiment. The water purifier according to an embodiment may include a main body 10 and the water dispensing apparatus 100.

The main body 10 may be equipped with a filter that is connected to a city water line via a pipe and filters water introduced from the city water line, a heating apparatus that heats filtered water to produce hot water, a cooling apparatus that cools filtered water to produce cold water, multiple pipes that form flow channels of water, and valves, sensors, and other various devices disposed in the pipes.

In addition, the main body 10 may be equipped with a controller that controls an operation of the water purifier. The controller may control an operation of a driver 130 equipped in the water dispensing apparatus 100, so that a body 120 and a water dispenser may operate in the vertical direction. In addition, the controller may control operations of various electrical components equipped in the water dispensing apparatus 100 or be in communication therewith.

The water purifier may be equipped with the water dispensing apparatus 100. The water dispensing apparatus 100 may be mounted in the main body 10 and may discharge drinking water including filtered room-temperature purified water, cooled cold water, and heated hot water based on selection of a user.

A container for receiving water, for example, a cup, may be placed below the water dispensing apparatus 100, and the user may receive discharged drinking water in the cup and drink the same. Hereinafter, the water dispensing apparatus 100 according to an embodiment will be described in detail with reference to the drawings.

The water dispensing apparatus 100 may include a water dispenser 110, the body 120, a driver 130, a base 140, a shaft 150, and an upper cover 160.

Water for the user to drink may be discharged from the water dispenser 110. Depending on the user's selection, room-temperature purified water, cooled cold water, and heated hot water may be discharged from the water dispenser 110. The water dispenser 110 may be disposed to be accommodated inside the body 120.

The body 120 may have a space defined therein to accommodate the water dispenser 110 therein. The body 120 may be roughly formed in a shape of a hollow circular column. The body 120 may be coupled with the driver 130 by a gear device, and may move in the vertical direction of the water purifier as a rotation shaft of the driver 130 rotates.

As the body 120 moves in the vertical direction, the water dispenser 110 disposed inside the body 120 also moves in the vertical direction together with the body 120, so that a distance to the cup for receiving drinking water placed below the water dispensing apparatus 100 may be adjusted.

Therefore, the water purifier may appropriately adjust a distance between an upper end of the cup having various sizes and a lower end of a sixth flow channel 2723, which is a distal end of the water dispensing apparatus 100 where water is discharged, so that discharged water may be quietly poured into the cup without splashing.

The driver 130 may be disposed outside of the body 120 and may move the water dispenser 110. The driver 130 may be coupled with the body 120 by the gear device at the location outside the body 120. Because the driver 130 having a considerable volume is disposed outside of the body 120, the water dispenser 110 having a considerable volume may be disposed inside the body 120.

In an embodiment, a volume of the body 120 may be significantly reduced by placing the water dispenser 110 inside the body 120 and placing the driver 130 that moves the body 120 and the water dispenser 110 in the vertical direction outside the body 120.

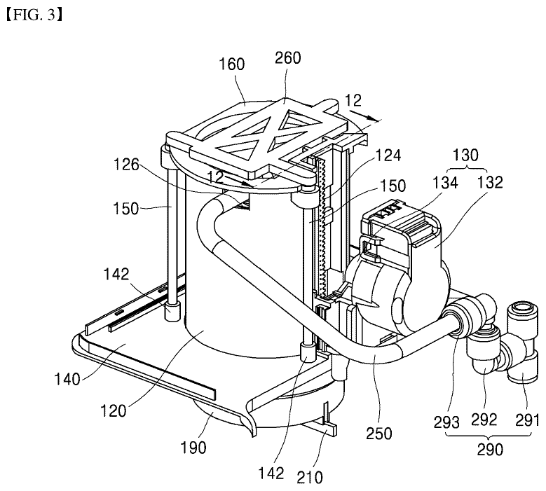

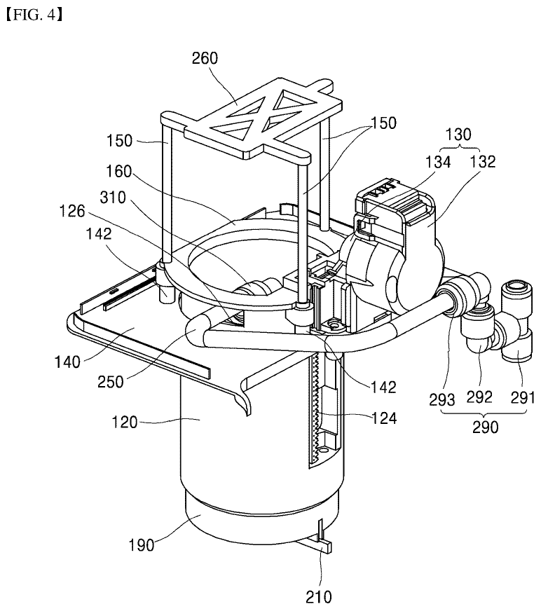

FIG. 3 is a perspective view of the water dispensing apparatus 100 according to an embodiment. FIG. 4 is a perspective view showing a descended state of the body 120 in FIG. 3.

The base 140 may be disposed such that the driver 130 is coupled thereto and the body 120 is movable. An accommodation hole 141 in which the body 120 is accommodated may be defined in the base 140, and the body 120 may move in the vertical direction within the accommodation hole 141.

The shaft 150 may be coupled to the base 140 and may guide the movement of the body 120. The body 120 may be slidably in contact with the shaft 150 and be guided by the shaft 150 to move in the vertical direction.

The shaft 150 may be coupled to the base 140 and guide the smooth movement of the body 120. The shaft 150 may be formed in a bar shape with a circular cross-section whose longitudinal direction is oriented in the vertical direction.

The shaft 150 may include a plurality of shafts to stably support and guide the body 120. The plurality of shafts 150 may be arranged to be spaced apart from each other in a circumferential direction of the body 120 having the circular shape. In FIGS. 3 and 4, three shafts 150 are illustrated, but four or more shafts 150 may be equipped in another embodiment.

The upper cover 160 may be coupled to the body 120, be in contact with the shaft 150, and move in a sliding manner relative to the shaft 150. The upper cover 160 may be coupled to an upper end of the body 120. The upper cover 160 may include a cover 162 having a substantially circular shape corresponding to the shape of the body 120 and having a predetermined width.

Therefore, the upper cover 160 may be coupled to the upper end of the body 120 and reinforce a rigidity of the body 120, which is relatively thin, so that even when an external impact is applied to the body 120, deformation of the body 120 may be suppressed, thereby protecting the water dispenser 110 accommodated inside.

The water dispensing apparatus 100 may be equipped with a pipe through which water flows, which is connected to the water dispenser 110 and another component of the water purifier. Because the water dispenser 110 moves in the vertical direction of the water purifier, such a pipe needs to correspond to the movement of the water dispenser 110.

Therefore, the pipe needs to be formed such that at least a portion thereof is deformable or moveable. Accordingly, the pipe may be made of a flexible material that may be easily bent or curved for easy deformation.

When the pipe is made of the flexible material, the pipe may be deformed and changed in location as the water dispenser 110 moves. At this time, the pipe may not be uniformly deformed and a portion thereof may be folded. In addition, as the pipe is deformed and changed in location, the pipe may be caught on another component.

Therefore, because the above-mentioned problems occur when using the pipe of the flexible material pipe, a pipe made of a rigid material may be equipped in practice. This will be described in detail.

The water dispensing apparatus 100 may include a first pipe 250 connected to the water dispenser 110 and made of a rigid material. The first pipe 250 may be made of, for example, a stainless steel material having good corrosion resistance against water.

The water dispenser 110 may be disposed inside the body 120, and the driver 130 may be disposed outside the body 120. When the body 120 ascends to its maximum, the water dispenser 110, the driver 130, and a fitting 290 may be positioned generally in a straight line. The first pipe 250 may be formed in a ‘U’ shape, so that one side thereof may be connected to the water dispenser 110 and the other side thereof may be connected to the fitting 290.

The first pipe 250 is preferably composed of a single pipe, but may also be composed of a plurality of pipes. When the first pipe 250 is composed of the plurality of pipes, the plurality of pipes may be connected to each other by separate links.

The water dispenser 110 may move as the body 120 moves, and the first pipe 250 may rotate as the water dispenser 110 moves. Because the first pipe 250 is made of the rigid material, the first pipe 250 may rotate in response to the movement of the water dispenser 110 without being bent or curved.

A portion of the first pipe 250 may be introduced into the body 120, and the first pipe 250 may rotate with respect to the body 120. Accordingly, a cutout 126 into which the first pipe 250 is inserted may be defined in the body 120 at a location where the first pipe 250 is introduced into the body 120.

The cutout 126 may be defined as the upper end of the body 120 is sunken. In addition, an open distal end of the cutout 126 may be covered by the upper cover 160. For the first pipe 250 to rotate smoothly without being obstructed by the body 120, an area size of the cutout 126 needs to be sufficiently greater than a cross-sectional area size of the first pipe 250.

For the first pipe 250 to rotate smoothly, the water dispensing apparatus 100 may include the fitting 290. The fitting 290 may be connected to the first pipe 250 and may have at least one rotatable link. One end of the first pipe 250 may be connected to a water inlet 111 disposed in the water dispenser 110 and the other end thereof may be connected to the fitting 290.

To connect the first pipe 250 with the water inlet 111, a fastening fitting 310 to which each of one end of the first pipe 250 and one end of the water inlet 111 is coupled may be separately disposed in the water dispensing apparatus 100.

For the first pipe 250 to smoothly rotate in response to the movement of the body 120, the first pipe 250 needs to be capable of so-called two-axis rotation of rotating around one axis and rotating around another axis that is orthogonal to said one axis.

To this end, the fitting 290 may include a plurality of links. The fitting 290 may include a first link 291, a second link 292, and a third link 293. The first link 291 may connect the first pipe 250 to other pipes disposed in the main body 10 through which water that has passed through other apparatuses of the water purifier, such as the filter, the heating apparatus, and the cooling apparatus, flows.

The second link 292 may be rotatably coupled to the first link 291. The third link 293 may be connected to the first pipe 250 and may be rotatably coupled to the second link 292. A rotation axis of the second link 292 and a rotation axis of the third link 293 may be arranged to be orthogonal to each other.

Because of such a structure, the first pipe 250 may perform the two-axis rotation by the first link 291 and the second link 292. Accordingly, when the water dispenser 110 accommodated in the body 120 moves in the vertical direction of the water dispensing apparatus 100, the first pipe 250 may smoothly rotate in response to such a movement and the water dispenser 110 may move without being obstructed by the first pipe 250.

In an embodiment, the first pipe 250 is made of the rigid material, so that it is not folded or caught on another component, compared to a case where it is made of a flexible material, thereby improving an operating performance of the water dispensing apparatus 100. At the same time, because the first pipe 250 is able to perform the two-axis rotation, the water dispensing apparatus 100 may move smoothly in the vertical direction without being obstructed by the first pipe 250.

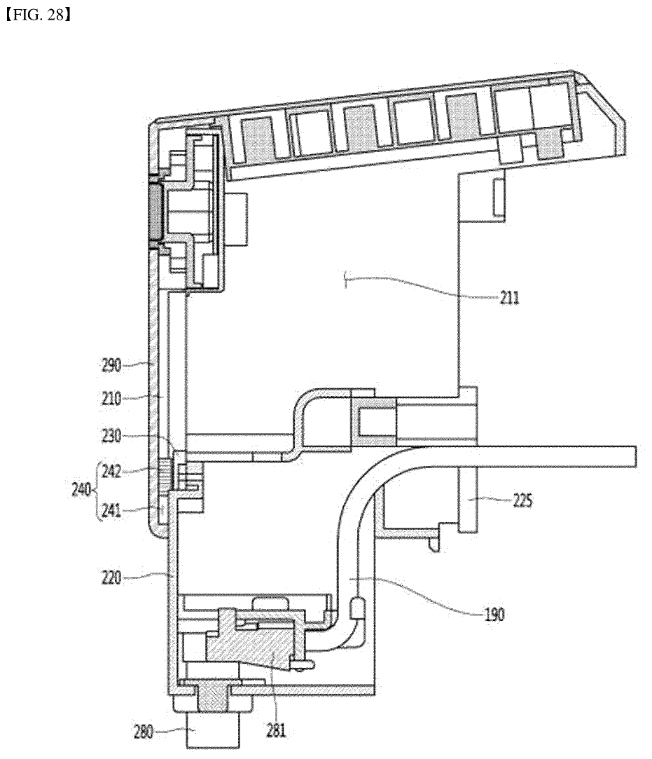

Referring to FIGS. 27 and 28, prior art 1 and the water purifier in the embodiment are compared with each other. FIGS. 27 and 28 are diagrams showing the prior art 1.

In the prior art 1, disclosed is a structure in which a movable casing 220 is accommodated in an ascending/descending space 211 of a fixed casing 210 and ascends and descends, and a supply hose 190 passes through a rear surface of the movable casing 220. In the case of the prior art 1, the entire supply hose 190 ascends and descends as the movable casing 220 ascends and descends.

In such a structure, there is a problem that the supply hose 190 is bent or damaged during the ascending and descending of the movable casing 220, and as a result, the supply hose 190 deviates from a connecting member 281.

In an embodiment, to solve such a problem, the cutout 126 may be defined in a side surface of the body 120, and the first pipe 250 may pass through the cutout 126. The fitting 290 may be disposed at the rear of the body 120, and one side of the first pipe 250 may perform axis rotation with respect to the fitting 290. According to an embodiment, even when the body 120 moves in the vertical direction, the first pipe 250 connected to the water dispenser 110 may not be bent or damaged.

According to an embodiment, as illustrated in FIG. 1, the water dispenser 110, the driver 130, and the fitting 290 may be arranged in the main body 10 so as to be spaced apart from each other in the front and rear direction of the main body 10.

According to another embodiment, the water dispenser 110, the driver 130, and the fitting 290 may be arranged in the main body 10 so as to be spaced apart from each other in a direction intersecting the front and rear direction of the main body 10, that is, in the left and right direction of the main body 10.

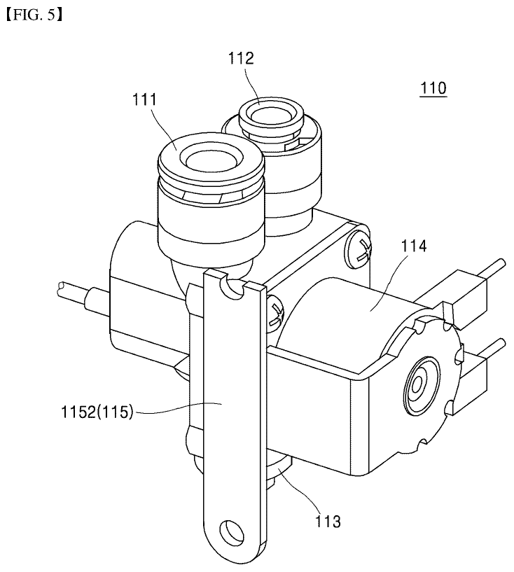

FIG. 5 is a diagram showing the water dispenser 110 according to an embodiment. The water dispenser 110 may include the water inlet 111, a drainage 112, a first nozzle 113, and a control valve 114.

Water for the user to drink may be introduced into the water inlet 111. A pipe disposed in the water purifier may be connected to the water inlet 111, and the water inlet 111 may become a passage through which water for the user to drink, such as purified water, cold water, or hot water, is introduced into the water dispenser 110.

The drainage 112 may be connected to the water inlet 111 and may discharge water introduced into the water inlet 111 to the outside. The drainage 112 may be connected to a drain pipe for discharging water to the outside of the water purifier.

A portion of water introduced into the water inlet 111 needs to be drained to the outside of the water purifier without being discharged as drinking water via the first nozzle 113.

For example, an initially discharged portion of water discharged as drinking water may not be sufficiently cooled or heated and thus may be discarded. Further, the initially discharged portion of water may be discarded for sanitary reasons. In addition, when using water to clean and sterilize the pipes and the components inside the water purifier, the water for the cleaning and the sterilization may be introduced into the water dispenser 110, and it may be unsanitary to allow such water to flow through a path for drinking.

Therefore, water introduced into the water inlet 111 needs to be discarded out of the water purifier instead of being used as drinking water. In this regard, water introduced into the water inlet 111 may be drained to the outside via the drainage 112.

The first nozzle 113 may be connected to the water inlet 111 and may discharge water for the user to drink. The first nozzle 113 may be connected to a sterilizer 270. Therefore, water discharged via the first nozzle 113 may pass through the sterilizer 270, and finally be discharged from the water purifier and put into the cup.

The control valve 114 may control opening and closing of the water inlet 111, the drainage 112, and the first nozzle 113. The control valve 114 may be equipped as a three-way valve. The three-way valve described herein may be coupled with three pipes, and may connect any two of the three pipes to each other or close all three pipes.

An operation of the control valve 114 may be controlled by the controller, and each of three inlets (or outlets) of the control valve 114 may be connected to the three pipes, namely, the water inlet 111, the first nozzle 113, and the drainage 112, respectively.

The control valve 114 may connect the water inlet 111 with the first nozzle 113 and close the drainage 112, connect the water inlet 111 with the drainage 112 and close the first nozzle 113, or close all of the water inlet 111, the first nozzle 113, and the drainage 112.

Therefore, depending on the operation of the control valve 114, water introduced into the water inlet 111 may flow to the first nozzle 113 or flow to the drainage 112 and be drained to the outside. In addition, when drinking water is not discharged from the water purifier, the control valve 114 may close the water inlet 111.

In the water dispensing apparatus 100, drinking water may be finally discharged into the cup via a distal end of a second nozzle 272 disposed in the sterilizer 270. In an embodiment, the water dispenser 110 and the sterilizer 270 may be connected to each other and both may be disposed in the body 120. Because of such a structure, a distance between the control valve 114 and the distal end of the second nozzle 272 may be very small.

When the control valve 114 is disposed outside the body 120, the second nozzle 272 disposed in a lower portion of the body 120 and the control valve 114 have no choice but to be connected to each other using a separate additional pipe. In this case, a distance between the control valve 114 and the distal end of the second nozzle 272 may become great.

When the distance between the control valve 114 and the distal end of the second nozzle 272 is great, water that has passed through the control valve 114 may undergo a great amount of heat transfer with outside air before being discharged from the second nozzle 272. Accordingly, cold water may receive heat from the outside and become lukewarm, and hot water may release heat to the outside and be cooled.

In an embodiment, among the water dispenser 110 and the driver 130, which occupy the considerable volume, the water dispenser 110 may be accommodated inside the body 120, and the driver 130 may be disposed outside the body 120. In addition, at least a portion of the sterilizer 270 may be disposed inside the body 120. Accordingly, the water dispenser 110 and the sterilizer 270 may be disposed adjacent to each other, and may be coupled to each other to form a flow channel through which water flows.

Because of such a structure, the control valve 114 disposed in the water dispenser 110 and the second nozzle 272 disposed in the sterilizer 270 may be disposed adjacent to each other. In addition, the control valve 114 and the distal end of the second nozzle 272 are not connected to each other by the separate additional pipe, so that the distance therebetween is very small.

Therefore, because there is almost no heat transfer with outside air between the control valve 114 and the distal end of the second nozzle 272, the heating of cold water or the cooling of hot water may be effectively suppressed.

Accordingly, water that has passed through the control valve 114 may be discharged to the outside via the second nozzle 272 while maintaining a set temperature, thereby providing convenience to the user.

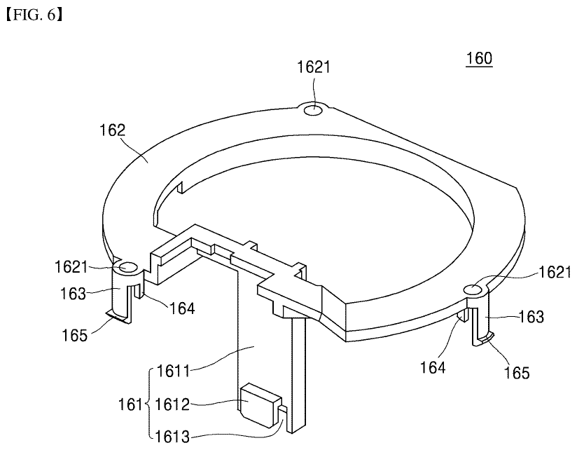

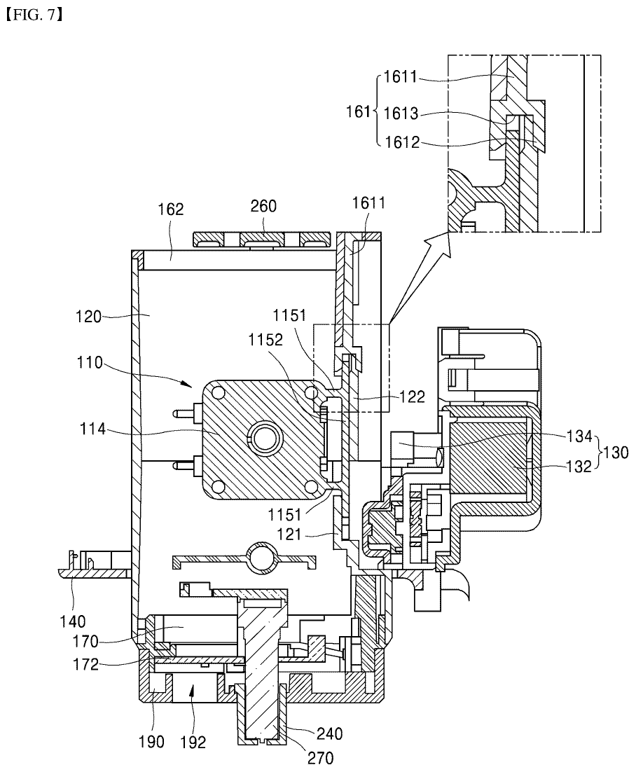

FIG. 6 is a diagram showing the upper cover 160 according to an embodiment. FIG. 7 is a cross-sectional view of some components of the water dispensing apparatus 100.

The water dispenser 110 may include a first mounting portion 115 extending from the control valve 114 and mounting the water dispenser 110 in the body 120. The first mounting portion 115 may be formed integrally with the control valve 114 and may removably couple the water dispenser 110 to the body 120.

The first mounting portion 115 may be formed integrally with a cover of the control valve 114, and may include a first cell 1151 and a second cell 1152. The first cell 1151 may protrude from the control valve 114. The first cell 1151 may include a plurality of first cells spaced apart from each other so as to support a load of the water dispenser 110 when the water dispenser 110 is mounted in the body 120.

The second cell 1152 may extend from the first cell 1151 and may be disposed such that a longitudinal direction thereof is parallel to a longitudinal direction of the body 120. The second cell 1152 may be formed in a plate-shaped bar shape and may be fitted between a first part 121 and a second part 122 of the body 120.

The body 120 may include the first part 121 and the second part 122. The first part 121 may protrude inwardly of the body 120 and may be in contact with one surface of the second cell 1152 to support the second cell 1152. The second part 122 may be disposed to be spaced apart from the first part 121 and may be in contact with the other surface of the second cell 1152.

The first part 121 and the second part 122 may be spaced apart from each other in the vertical direction of the water dispensing apparatus 100 and may support lower and upper portions of the second cell 1152, respectively. The first part 121 may protrude inwardly of the body 120, and the second part 122 may protrude inwardly of the body 120.

Therefore, a gap may be defined between an outer surface of the first part 121 and an inner surface of the second part 122 in a diameter direction of the body 120. The second cell 1152 may be placed in such a gap. Therefore, a width of such a gap is appropriately designed such that the second cell 1152 is stably maintained in a state of being mounted in the body 120 and the second cell 1152 is tightly fitted for the water dispenser 110 not to shake, in consideration of a thickness of the second cell 1152.

The second cell 1152 may be mounted between the first part 121 and the second part 122 by sliding, or may be removed therefrom by sliding. For example, when coupling the water dispenser 110 to the body 120, the second cell 1152 of the water dispenser 110 may be slid between the first part 121 and the second part 122 and may be inserted into the gap therebetween to mount the water dispenser 110 in the body 120.

When removing the water dispenser 110 from the body 120, the second cell 1152 may be slid between the first part 121 and the second part 122 and may be pulled out from the gap therebetween, thereby separating the water dispenser 110 from the body 120.

The upper cover 160 may further include a second mounting portion 161 for mounting the water dispenser 110 in the body 120. The second mounting portion 161 may be coupled to an upper end of the second part 122 of the body 120 and an upper end of the second cell 1152 of the water dispenser 110 and prevent the second cell 1152 from deviating from the gap between the first part 121 and the second part 122 when the upper cover 160 is coupled to the body 120.

The second mounting portion 161 may include a first piece 1611 and a first hook 1612. The first piece 1611 may protrude downward from the cover 162 of the upper cover 160, and may be positioned at a location corresponding to the second cell 1152 and the second part 122 when the upper cover 160 is coupled.

The first hook 1612 may be disposed at an end of the first piece 1611 and may be coupled to ends of the second cell 1152 and the second part 122 to prevent the second cell 1152 from moving upward. The first hook 1612 may have edges on both sides protruding to define a coupling groove 1613 therebetween, and the ends of the second cell 1152 and the second part 122 may be inserted into the coupling groove 1613.

The ends of the second cell 1152 and the second part 122 may be inserted into the coupling groove 1613 and mounted in the second mounting portion 161.

In an embodiment, the water dispenser 110 may have the first mounting portion 115, and the first mounting portion 115 may be mounted in the gap between the first part 121 and the second part 122 of the body 120 by sliding or may be removed from such a gap by sliding. In addition, the upper cover 160 may have the second mounting portion 161 to prevent the second cell 1152 of the first mounting portion 115 from moving upward and being easily removed from the body 120.

Because of such a structure, the water dispenser 110 may be easily mounted in and removed from the body 120, so that assembly and disassembly of the water dispensing apparatus 100 may be facilitated.

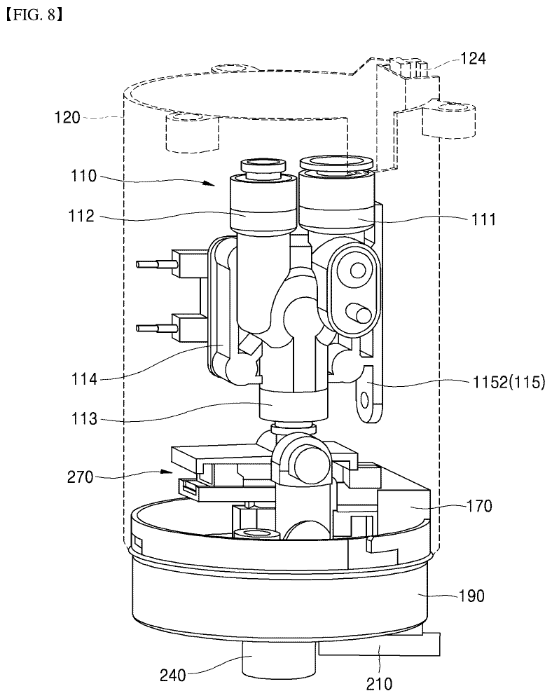

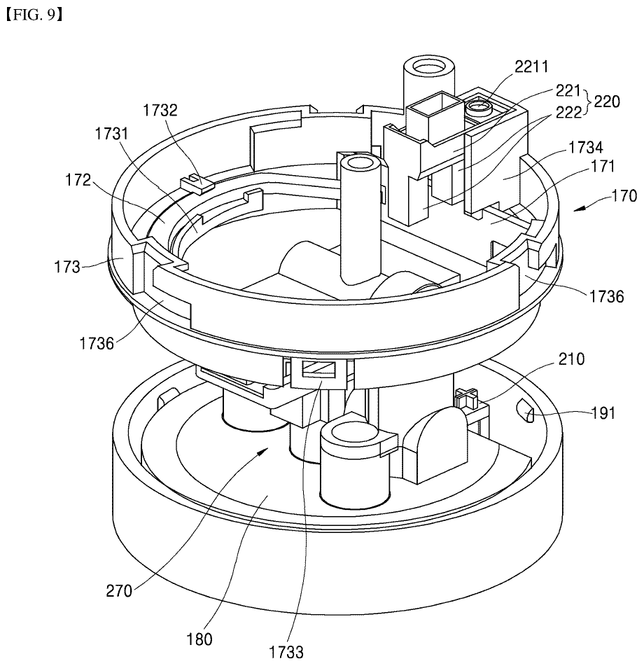

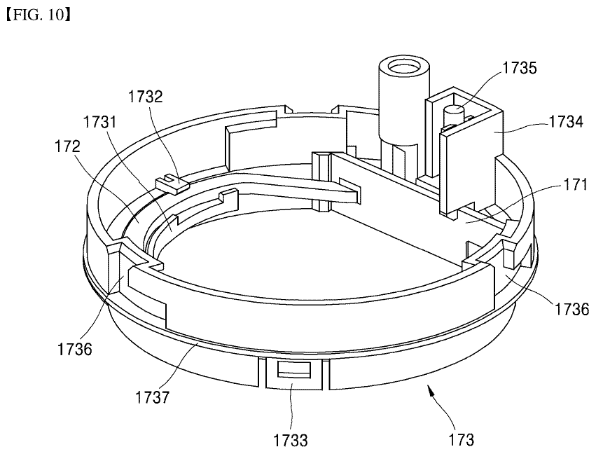

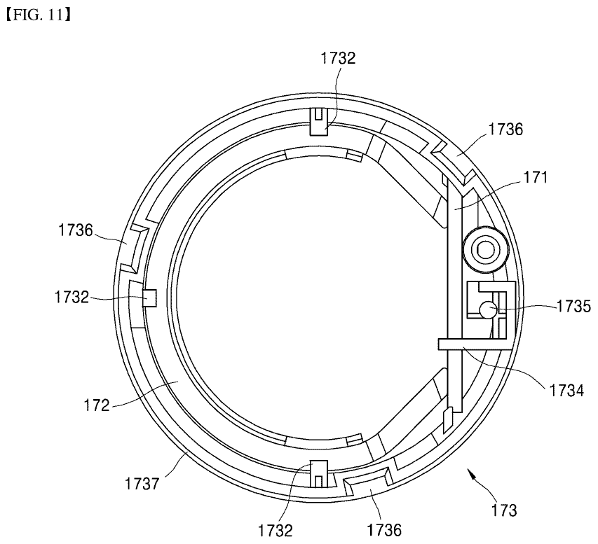

FIG. 8 is a diagram of some components of the water dispensing apparatus 100. FIG. 9 is a perspective view of some components of the water dispensing apparatus 100. FIG. 10 is a perspective view showing a state in which a third substrate 171 and a light ring 173 are coupled to each other. FIG. 11 is a plan view of FIG. 10.

The water dispensing apparatus 100 may include a light-emitter 170, a second substrate 180, and a lower cover 190. The light-emitter 170 may be disposed in the lower portion of the body 120. When drinking water is discharged, the light-emitter 170 may irradiate light to inform the user that water is being discharged. In addition, the light-emitter 170 may irradiate light to inform the user of operating states of various components of the water purifier.

The second substrate 180 may be disposed so as to be surrounded by the light-emitter 170 and may irradiate an ultrasonic wave. The second substrate 180 may sense a location of the cup using the ultrasonic wave. The second substrate 180 may be equipped with an ultrasonic sensing device including various active elements, passive elements, and circuits necessary for irradiating the ultrasonic wave and sensing the location of the cup.

When the user presses a water dispense button, the ultrasonic sensing device equipped in the second substrate 180 may operate, and the ultrasonic sensing device may sense the location of the cup.

When the cup for containing water is placed under the water dispensing apparatus 100, the second substrate 180 may sense a location of the water dispensing apparatus 100 relative to the upper end of the cup, specifically a location of a lower end of the second nozzle 272, by irradiating the ultrasonic wave toward the cup.

The controller may receive information regarding a vertical level of the upper end of the cup from the second substrate 180, determine a movement direction and a movement distance of the water dispensing apparatus 100 based on the vertical level of the cup, and operate the driver 130 to move the water dispensing apparatus 100 in the set movement direction and movement distance.

The light emitter 170 and the second substrate 180 may be seated on the lower cover 190, and the lower cover 190 may be mounted at a lower end of the body 120. A lower end of the lower cover 190 may be coupled to the body 120 to close the lower end of the body 120, thereby protecting the components accommodated in the body 120.

The light-emitter 170 may include the third substrate 171, a light diffuser 172, and the light ring 173. The third substrate 171 may be equipped with a light source that irradiates visible light. The third substrate 171 may be equipped with various active elements, passive elements, and circuits necessary for irradiating visible light.

The light diffuser 172 may be connected to the light source equipped in the third substrate 171 and may be formed in a ring shape. The light diffuser 172 may allow light incident from the light source to be evenly diffused throughout the same, and light thus diffused may be incident on the light ring 173 to evenly illuminate the entire light ring 173.

The light ring 173 may allow the light diffuser 172 to be disposed therein, be mounted in the body 120, and outwardly irradiate light that has passed through the light diffuser 172 and is incident thereon. The light ring 173 may be generally formed in a ring shape, and like the light diffuser 172, may allow light incident from the light diffuser 172 to be evenly diffused throughout the same and may outwardly irradiate light.

The light ring 173 may include a seating ring 1731 and a first mounting protrusion 1732. The seating ring 1731 may protrude from an inner surface of the light ring 173 and may allow the light diffuser 172 to be seated thereon. The seating ring 1731 may protrude diametrically from the inner surface of the light ring 173, may have a longitudinal direction defined in a circumferential direction of the light ring 173, and may be formed in a shape corresponding to that of the light ring 173.

The first mounting protrusion 1732 may protrude from the inner surface of the light ring 173, may be disposed above the seating ring 1731, and may mount the light diffuser 172 on the seating ring 1731. The first mounting protrusion 1732 may include a plurality of first mounting protrusions, and the plurality of first mounting protrusions may be arranged to be spaced apart from each other in the circumferential direction of the light ring 173.

The light diffuser 172 may be mounted inwardly of the light ring 173 by being seated on the seating ring 1731 and supported by the first mounting protrusion 1732.

The light ring 173 may include an exposed portion 1737. The exposed portion 1737 may protrude from an outer surface of the light ring 173 and may be disposed such that a longitudinal direction thereof is defined in the circumferential direction of the light ring 173. When the body 120 and the lower cover 190 are coupled to the light ring 173, the exposed portion 1737 may be exposed to the outside, and the light ring 173 may irradiate light to the outside via the exposed portion 1737. The user may see that the exposed portion 1737 is shining.

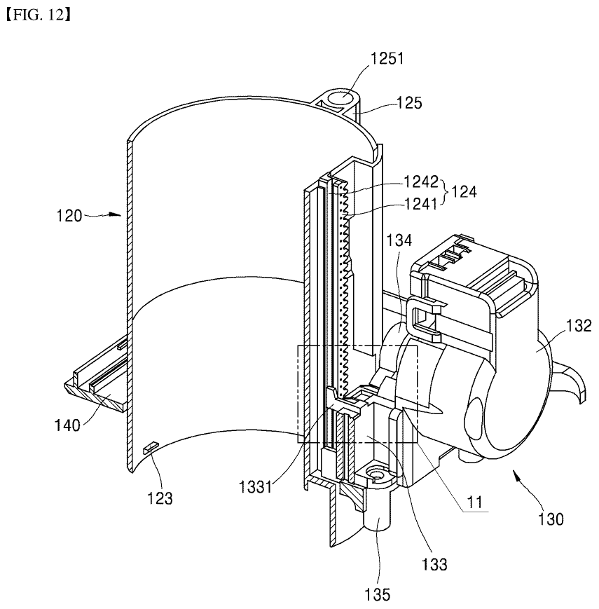

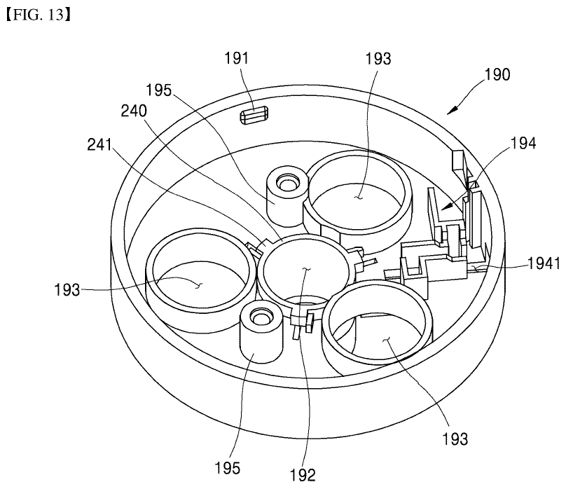

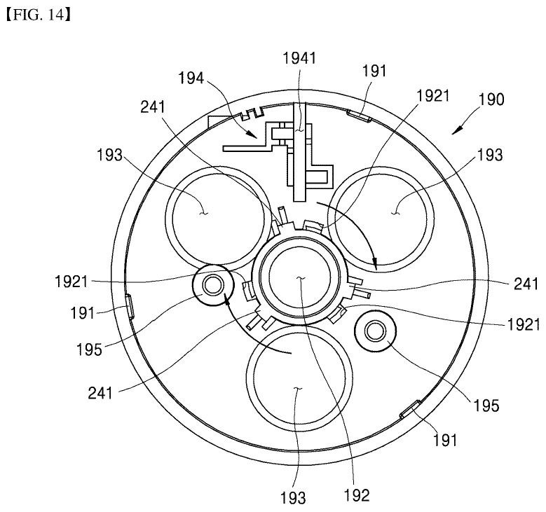

FIG. 12 is a perspective view showing a cross-section of the body 120. FIG. 13 is a perspective view showing the lower cover 190. FIG. 14 is a plan view of FIG. 13.

The light ring 173 may be mounted on the lower cover 190. To this end, the lower cover 190 may include a second mounting protrusion 191, and the light ring 173 may include a first mounting groove 1733.

The second mounting protrusion 191 may protrude from the inner surface of the lower cover 190 and may allow the light ring 173 to be mounted. The second mounting protrusion 191 may protrude from an inner surface of a side surface of the lower cover 190 and may include a plurality of second mounting protrusions arranged to be spaced apart from each other in the circumferential direction of the lower cover 190.

The first mounting groove 1733 may be defined at a location in the light ring 173 corresponding to the second mounting protrusion 191 of the lower cover 190, and may allow the second mounting protrusion 191 to be mounted therein. The first mounting groove 1733 may be formed in an overall hook shape with a portion of the light ring 173 cut out and a hole in a center. The first mounting groove 1733 may include a plurality of first mounting grooves arranged to be spaced apart from each other in the circumferential direction of the light ring 173.

Because the first mounting groove 1733 is defined by cutting out the portion of the light ring 173, elastic deformation is available. Therefore, when the light ring 173 is pressed against the lower cover 190, the first mounting groove 1733 is elastically deformed, so that the second mounting protrusion 191 of the lower cover 190 may be fitted into the hole of the first mounting groove 1733, and thus the light ring 173 and the lower cover 190 may be coupled to each other.

The lower cover 190 may include a first hole 192 and a second hole 193. The first hole 192 may be defined at a center of the lower cover 190, and may have an extension 240 mounted therein. A first groove 1921 for mounting the extension 240 may be defined in the first hole 192.

The first groove 1921 may include a plurality of first grooves arranged to be spaced apart from each other in a circumferential direction of the first hole 192, and may be defined by being recessed from the first hole 192. In response thereto, a fourth mounting protrusion 241 may be formed on the extension 240.

The fourth mounting protrusion 241 may protrude from an outer surface of the extension 240 and may include a plurality of fourth mounting protrusions arranged to be spaced apart from each other. When the fourth mounting protrusion 241 of the extension 240 is inserted into the first groove 1921 of the first hole 192 and the extension 240 is rotated in the circumferential direction of the lower cover 190 as shown by an arrow in FIG. 14, the extension 240 may be coupled to the lower cover 190.

The second hole 193 may include a plurality of second holes to surround the first hole 192, and may allow the ultrasonic wave irradiated from the second substrate 180 to pass therethrough. An ultrasonic transmitter 181 or an ultrasonic receiver 182 may be inserted into each second hole 193.

The lower cover 190 may include a fifth fastener 195 that couples the sterilizer 270 mounted on the water dispenser 110 to the lower cover 190. The fifth fastener 195 may be formed to protrude from an inner bottom surface of the lower cover, and may include a plurality of fifth fasteners.

The fifth fastener 195 may be fastened to a second fastener 2725 disposed on the sterilizer 270 by a fastening mechanism such as a screw. As a result, the sterilizer 270 may be stably coupled to the lower cover 190.

Referring to FIG. 12, the body 120 may include a third mounting protrusion 123 that protrudes from an inner surface of the body 120 and mounts the light ring 173 in the body 120. The third mounting protrusion 123 may include a plurality of third mounting protrusions disposed on the inner surface of the body 120 and arranged to be spaced apart from each other in the circumferential direction of the body 120.

Referring to FIG. 11, the light ring 173 may include a second mounting groove 1736 defined by recessing the outer surface thereof and in which the third mounting protrusion 123 is mounted.

The second mounting groove 1736 may be defined at a location in the light ring 173 corresponding to the third mounting protrusion 123 of the body 120, and may allow the third mounting protrusion 123 to be mounted therein. The second mounting groove 1736 may be defined by recessing the outer surface of the light ring 173 and may include a plurality of second mounting grooves arranged to be spaced apart from each other in the circumferential direction of the light ring 173.

The light ring 173 may be coupled to the body 120 by inserting the third mounting protrusion 123 of the body 120 into the second mounting groove 1736 of the light ring 173 and rotating the light ring 173 in the circumferential direction of the body 120. To this end, the second mounting groove 1736 may include a portion formed in the vertical direction and a portion formed in the circumferential direction by bending from the above portion.

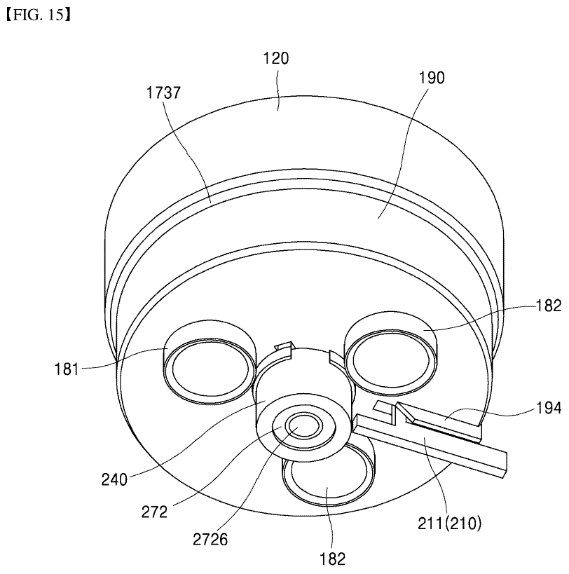

FIG. 15 is a diagram showing a state in which the lower cover 190 is mounted on the body 120. The second substrate 180 may transmit the ultrasonic wave in a downward direction and receive the ultrasonic wave that returns after hitting the cup placed below the water dispensing apparatus 100, and analyze a change in wavelength of the ultrasonic wave to identify the location of the upper end of the cup.

To this end, the second substrate 180 may include the ultrasonic transmitter 181 and the ultrasonic receiver 182. The ultrasonic transmitter 181 may be disposed at a location corresponding to the second hole 193, and the number of ultrasonic transmitters may be equal to or greater than one. The ultrasonic receiver 182 may be disposed at a location corresponding to each remaining second hole 193, except for the second hole 193 where the ultrasonic transmitter 181 is disposed, and the number of ultrasonic receivers may be equal to or greater than one.

In the embodiment illustrated in FIG. 15, one ultrasonic transmitter 181 and two ultrasonic receivers 182 are equipped. Except for the illustrated embodiment, in other embodiments, one or more ultrasonic transmitters 181 and one or two ultrasonic receivers 182 may be equipped.

The second substrate 180 may sense the distance between the lower end of the second nozzle 272 and the upper end of the cup for cups of various sizes by transmitting and receiving the ultrasonic wave, and the controller may move the body 120 in the vertical direction to appropriately adjust the distance between the lower end of the second nozzle 272 and the upper end of the cup based on the sensed distance.

In an embodiment, the water dispensing apparatus 100 may be equipped with the second substrate 180 that transmits and receives the ultrasonic wave to accurately identify the location of the upper end of the cup, and accordingly, the controller may appropriately adjust the distance between the lower end of the second nozzle 272 and the upper end of the cup.

Accordingly, water discharged from the second nozzle 272 may be quietly filled into the cup without splashing, thereby providing the convenience to the user.

In one example, the second substrate 180 may malfunction or operate abnormally, making it unable to accurately identify the location of the upper end of the cup. In this case, the body 120 and the water dispenser 110 may descend excessively and impact the cup, which may cause the cup to break or the water purifier to be damaged.

To prevent this risk, the water dispensing apparatus 100 in the embodiment may be equipped with a structure that prevents the body 120 and the water dispenser 110 from descending excessively. This will be described in detail below.

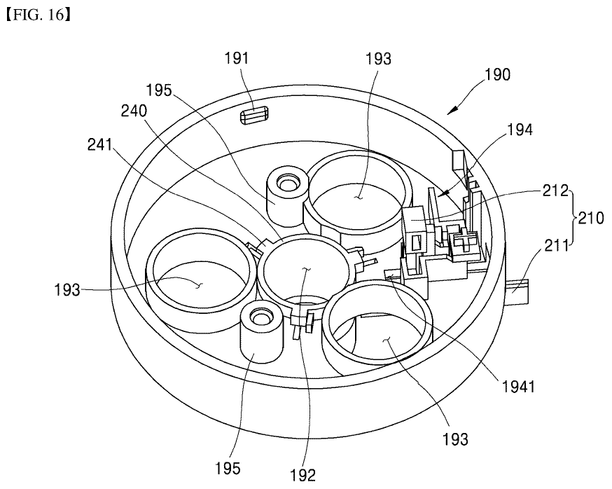

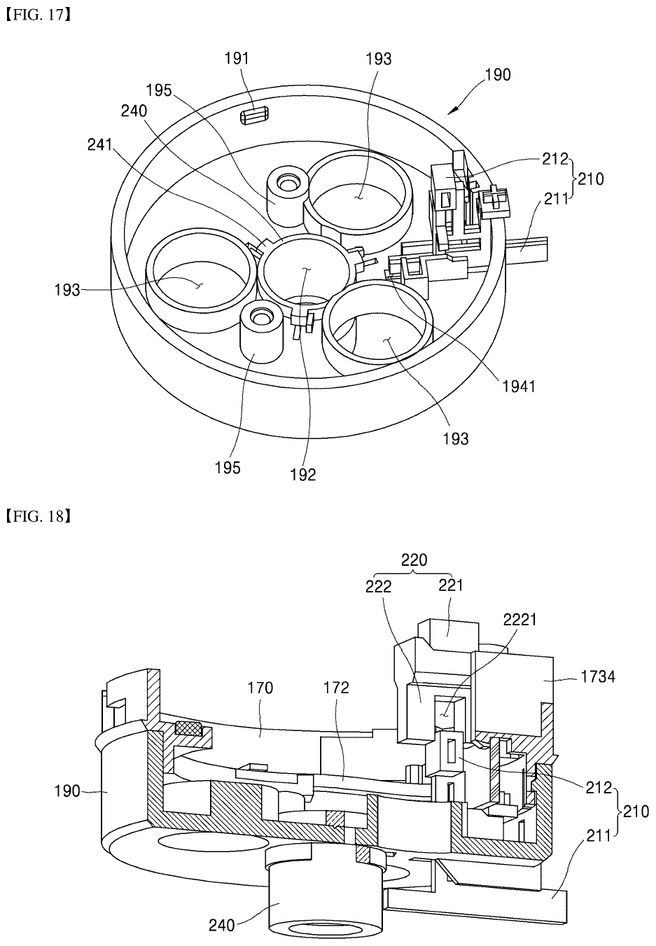

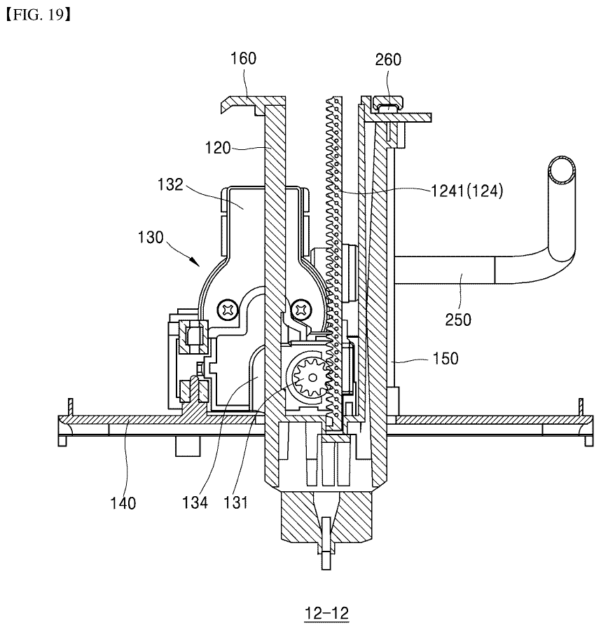

FIG. 16 is a diagram showing a state in which a stopper 210 is mounted in the lower cover 190. FIG. 17 is a diagram showing a state in which the stopper 210 in FIG. 16 has ascended. FIG. 18 is a diagram showing a state in which a photo sensor 220 is coupled to the light-emitter 170.

The water dispensing apparatus 100 may include the stopper 210 and the photo sensor 220. The stopper 210 may be movably disposed in the lower cover 190. When the body 120 and the lower cover 190 mounted thereon excessively descend, the stopper 210 may come into contact with the upper end of the cup.

The lower cover 190 may include a first mounting structure 194 where the stopper 210 is mounted movably with respect to the lower cover 190. A sliding hole 1941 in which the stopper 210 is inserted and moves while sliding with respect to the first mounting structure 194 may be defined in the first mounting structure 194.

The first mounting structure 194 may have a protruding structure formed at an edge of the sliding hole 1941 that is in contact with the stopper 210 in a sliding manner and is able to guide the movement of the stopper 210. The stopper 210 may be guided by the first mounting structure 194 and move by a predetermined distance in the vertical direction with respect to the lower cover 190.

The photo sensor 220 may stop the movement of the body 120 when the stopper 210 moves upward and blocks a photo detector 222. The photo sensor 220 may include a third mounting portion 221 and the photo detector 222.

The third mounting portion 221 may have a through-hole 2211 defined therein and may be mounted on the light ring 173. In this regard, the light ring 173 may include a pin-to-be-inserted 1735 inserted into the through-hole 2211 of the third mounting portion 221, and may include a second mounting structure 1734 on which the third mounting portion 221 is mounted.

The third mounting portion 221 may be mounted on the second mounting structure 1734 formed on the light ring 173, and the pin-to-be-inserted 1735 of the second mounting structure 1734 may be inserted into the through-hole 2211 of the third mounting portion 221. With such a structure, the third mounting portion 221 is mounted on the light ring 173, so that the photo sensor 220 may be stably mounted on the light ring 173.

The photo sensor 220 may be equipped with the photo detector 222 that senses external light. The photo detector 222 may be formed integrally with the third mounting portion 221, have a concave groove 2221, and may sense light.

The stopper 210 may include a contact sensor 211 and a protruding portion 212. The contact sensor 211 may protrude outwardly of the lower cover 190 and may sense contact with a container containing water, i.e., the cup. The contact sensor 211 may protrude downwardly of the lower cover and may be positioned to face the cup disposed below the water dispensing apparatus 100.

The protruding portion 212 may be formed integrally with the contact sensor 211 and may suppress the photo detector 222 from sensing light by being positioned in the concave groove 2221 when the container comes into contact with the contact sensor 211 and the stopper 210 moves upward.

Referring to FIG. 18, the photo detector 222 may be formed on one side of the concave groove 2221 to protrude downward. In addition, the photo detector 222 may sense light introduced thereinto in a direction of the concave groove 2221.

The concave groove 2221 may be defined at a location corresponding to the protruding portion 212. Therefore, when the stopper 210 ascends, the protruding portion 212 may also ascend to fill the concave groove 2221. As a result, light introduced into the photo detector 222 may change in brightness, and the photo detector 222 may sense the same.

When the protruding portion 212 of the stopper 210 blocks the photo detector 222, the photo sensor 220 may sense the change in the brightness of light and transmit an abnormality signal to the controller.

When the contact sensor 211 of the stopper 210 comes into contact with the upper end of the cup, the stopper 210 may ascend relative to the lower cover 190, and accordingly, the protruding portion 212 of the stopper 210 may block the photo detector 222 of the photo sensor 220. When the photo detector 222 of the photo sensor 220 is blocked, the photo sensor 220 may sense the same and transmit the signal to the controller.

The controller, which has received the signal from the photo sensor 220, may immediately stop the operation of the driver 130 to prevent the body 120 and the lower cover 190 from descending any further, thereby preventing the excessive descending of the body 120 and the lower cover 190.

In an embodiment, the stopper 210 and the photo sensor 220 may be equipped, and the stopper 210 may ascend and block the photo sensor 220 when it comes into contact with the upper end of the cup. Accordingly, the photo sensor 220 may transmit the abnormality signal to the controller, so that the controller may stop the operation of the driver 130.

As a result, the cup or the water dispensing apparatus 100 may be effectively prevented from being damaged because of the excessive descending of the body 120 and the lower cover 190.

The water dispensing apparatus 100 may include the extension 240 mounted in the first hole 192, disposed to surround the water dispenser 110, and having at least a portion protruding downward of the lower cover 190. The extension 240 may accommodate the sixth flow channel 2723 disposed in the second nozzle 272 therein.

The extension 240 may protect the sixth flow channel 2723, which is the distal end where drinking water is discharged, from external foreign substances. In addition, the extension 240 may be easily detachable from the lower cover 190 as described above.

Therefore, when the foreign substances are attached to the extension 240, the extension 240 may be removed from the lower cover 190 and washed, thereby facilitating a hygiene management of the water dispensing apparatus 100.

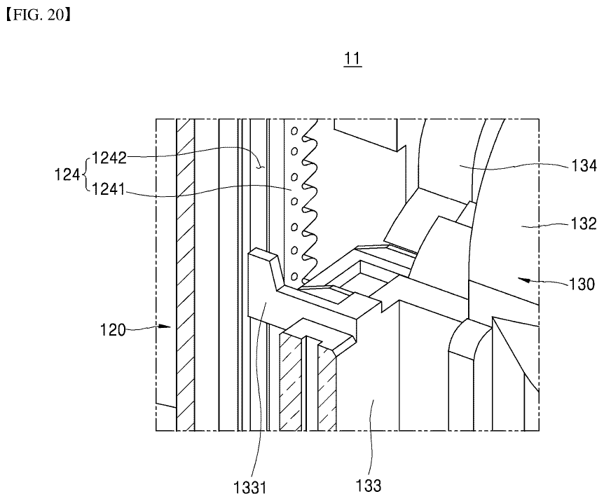

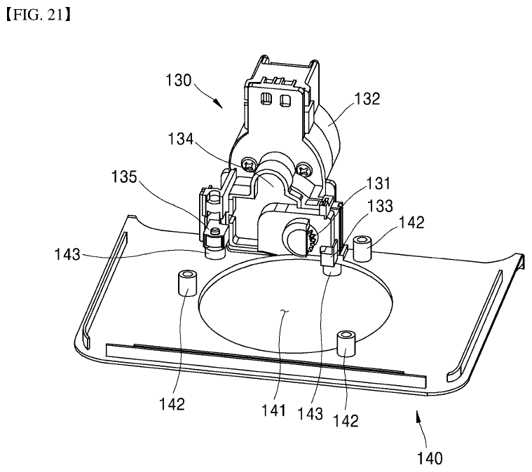

FIG. 19 is a cross-sectional view showing a direction 12-12 in FIG. 3. FIG. 20 is an enlarged view showing a portion 11 in FIG. 12.

The body 120, and the water dispenser 110 and the sterilizer 270 accommodated therein may move in the vertical direction of the water purifier based on the operation of the driver 130. To implement the same, the body 120 may be equipped with a rack gear 124, and the driver 130 may be equipped with a pinion gear 131.

The body 120 may include the rack gear 124 whose longitudinal direction is directed in the vertical direction of the body 120. The driver 130 may include the pinion gear 131 coupled with the rack gear 124 and coupled to the rotation shaft of the driver 130.

The rack gear 124 may be disposed at one side of the body 120 and may be formed linearly. The pinion gear 131 may be connected to a rotation shaft of a motor equipped in the driver 130 and may rotate based on rotation of the motor. The rack gear 124 and the pinion gear 131 may mesh with each other, so that the rack gear 124 may move in the vertical direction based on the rotation of the pinion gear 131, and accordingly, the body 120 may move in the vertical direction.

The pinion gear 131 may move the body 120 in the vertical direction by rotating clockwise or counterclockwise.

The rack gear 124 may include a gear forming portion 1241 and a guide groove 1242. The gear forming portion 1241 may have a longitudinal direction thereof directed in the vertical direction of the body 120 and may be coupled, i.e., meshed, with the pinion gear 131. The guide groove 1242 may be defined such that a longitudinal direction thereof is parallel to the longitudinal direction of the gear forming portion 1241.

The driver 130 may include a motor placement portion 132, a guide 133, and a pinion housing 134. The motor may be disposed in the motor placement portion 132. The motor placement portion 132 may be equipped with the motor and a casing that accommodates the motor therein.

The guide 133 may have a guide protrusion 1331 coupled to the motor placement portion 132 and seated in the guide groove 1242. The guide 133 may be coupled to the casing of the motor placement portion 132. The pinion housing 134 may be coupled to the guide 133 and may accommodate the pinion gear 131 therein.

The guide protrusion 1331 may be seated in the guide groove 1242 of the rack gear 124 and may slide with respect to the guide groove 1242 when the rack gear 124 moves in the vertical direction. The guide protrusion 1331 may guide the pinion housing 134 so as not to deviated from a range set for the rack gear 124 while the rack gear 124 moves. Accordingly, the gear forming portion 1241 and the pinion gear 131 may always maintain the state of meshing with each other.

Because of such a structure, as the guide protrusion 1331 is seated and slides in the guide groove 1242, the gear forming portion 1241 of the rack gear 124 and the pinion gear 131 of the driver 130 may maintain the state of being coupled with each other without being separated from each other. Therefore, when the driver 130 operates, the rack gear 124 and the body 120 coupled thereto may stably move in the vertical direction.

In an embodiment, the water dispensing apparatus 100 may be equipped with the rack gear 124 and the pinion gear 131, and the rack gear 124 may be equipped with the guide groove 1242 and the driver 130 may be equipped with the guide 133 such that the rack gear 124 and the pinion gear 131 may maintain the state of being coupled to each other while the driver 130 operates.

Therefore, the water dispensing apparatus 100 may stably move the water dispenser 110 in the vertical direction while having a simple structure.

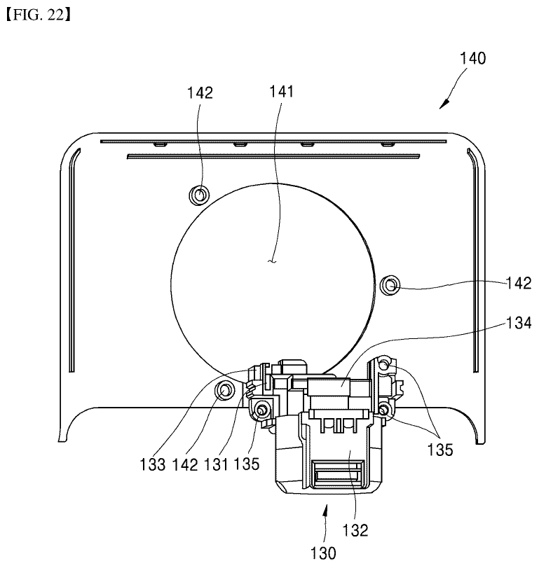

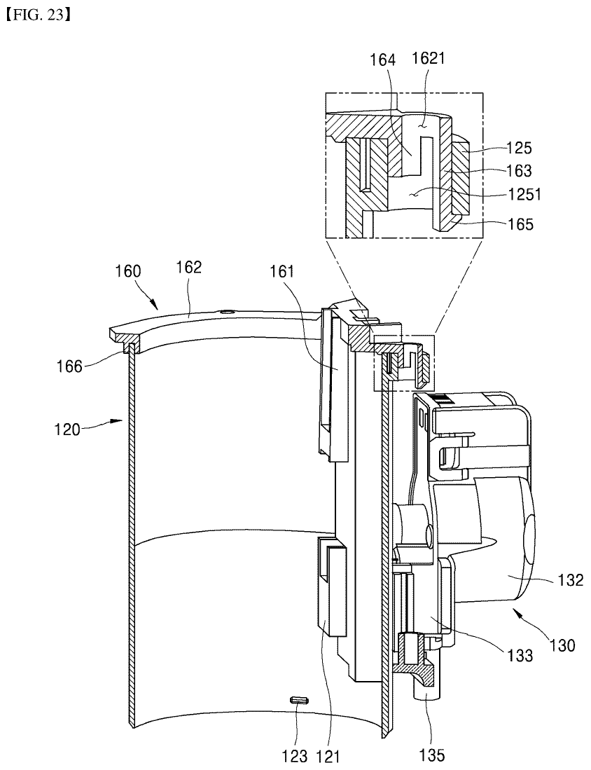

FIG. 21 is a diagram showing a state in which the driver 130 and the base 140 are coupled to each other. FIG. 22 is a diagram of FIG. 21 viewed from a different direction.

The water dispensing apparatus 100 may include the base 140 to which the driver 130 is coupled and in which the body 120 is movably disposed. The base 140 may be coupled to the main body 10 of the water purifier and may not move even when the driver 130 operates. The body 120 may be movably coupled to the base 140.

The base 140 may be formed roughly in a plate shape and may include the accommodation hole 141, a groove forming portion 142, and a fourth fastener 143. The accommodation hole 141 may be defined at a center of the base 140, and the body 120 may be accommodated therein. The body 120 may move relative to the base 140 while moving in the vertical direction in the accommodation hole 141.

The groove forming portion 142 may include a plurality of groove forming portions so as to surround the accommodation hole 141, and the plurality of groove forming portions may respectively have grooves in which the plurality of shafts 150 are mounted. The plurality of shafts 150 may be arranged to be spaced apart from each other in a circumferential direction of the accommodation hole 141.

The groove forming portion 142 may be formed to correspond to a shape and a location of an end of each of the plurality of shafts 150. The shaft 150 may be mounted on the base 140 by having the end thereof fitted into the groove of the groove forming portion 142.

To couple the driver 130 to the base 140, the driver 130 may be equipped with a third fastener 135. The third fastener 135 may include a plurality of third fasteners for stable coupling of the driver 130. The third fasteners 135 may be disposed on the motor placement portion 132 and the pinion housing 134, respectively.

The fourth fasteners 143 may be formed at locations corresponding to the third fasteners 135 disposed on the driver 130, with the same number as the third fasteners 135. The third fastener 135 and the fourth fastener 143 may be coupled to each other by the fastening mechanism such as a screw.

The body 120 may be designed to reciprocate with respect to the base 140, the shaft 150, and the driver 130 while being disposed in the accommodation hole 141. In the water dispensing apparatus 100, the base 140 may be coupled to the main body 10, and the shaft 150 and the driver 130 may be coupled to the base 140.

In this regard, the base 140, the shaft 150, and the driver 130 may not move, but the body 120 may move in the vertical direction of the water purifier based on the operation of the driver 130. The shaft 150 may stably guide the movement in the vertical direction of the body 120.

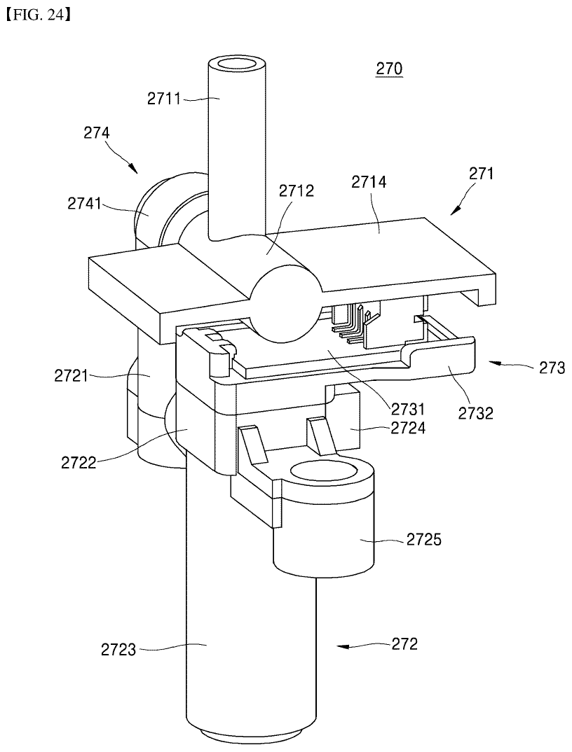

FIG. 23 is a diagram showing a state in which the body 120 and the upper cover 160 are coupled to each other. The body 120 may include a first coupling portion 125 that is disposed to protrude from an upper end of the body 120 and has a first insertion hole 1251 into which the shaft 150 is inserted. The shaft 150 may be inserted into the first insertion hole 1251 and guide the movement in the vertical direction of the body 120.

The upper cover 160 may be formed with a fitting groove 166 so as to be stably coupled to the upper end of the body 120. The fitting groove 166 may be formed such that a longitudinal direction thereof is directed in the circumferential direction of the upper cover 160. The upper end of the body 120 may be fitted into the fitting groove 166 of the upper cover 160, so that the upper cover 160 may be coupled to the body 120.

The upper cover 160 may include the cover 162, a first portion-to-be-inserted 163, a second portion-to-be-inserted 164, and a second hook 165. The cover 162 may include a second insertion hole 1621 defined at the upper end of the body 120 and into which the shaft 150 is inserted. When the upper cover 160 is coupled to the body 120, the cover 162 may cover the upper end of the body 120.

The first portion-to-be-inserted 163 may be formed to extend in a longitudinal direction from an edge of the second insertion hole 1621, protrude from the cover 162, and be inserted into the first insertion hole 1251.

The second portion-to-be-inserted 164 may be formed to extend in the longitudinal direction from the edge of the second insertion hole 1621, protrude from the cover 162, be inserted into the first insertion hole 1251, be spaced apart from the first portion-to-be-inserted 163, and be shorter than the first portion-to-be-inserted 163. The second hook 165 may be disposed at an end of the first portion-to-be-inserted 163.

When the upper cover 160 is fitted into the first insertion hole 1251 of the body 120, the second hook 165 may maintain a state of being fixed to the body 120 while protruding from a lower end of the first insertion hole 1251. Accordingly, the upper cover 160 may be stably coupled to the body 120.

The first portion-to-be-inserted 163 and the second portion-to-be-inserted 164 may be fitted into the first insertion hole 1251 of the body 120, and the shaft 150 may be inserted into the second insertion hole 1621 of the upper cover 160 so as to come into contact with inner surfaces of the first portion-to-be-inserted 163 and the second portion-to-be-inserted 164. Accordingly, the shaft 150 may be mounted on the upper cover 160 so as to be in contact with the first portion-to-be-inserted 163 and the second portion-to-be-inserted 164 in a sliding manner.

Depending on the operation of the driver 130, the body 120 and the upper cover 160 coupled to the body 120 move in the vertical direction, and accordingly, the shaft 150 and the first portion-to-be-inserted 163 and the second portion-to-be-inserted 164 of the upper cover 160 may be in contact with each other in a sliding manner.

In this regard, the upper cover 160 may be made of a material that has low frictional resistance and is easy to slide. For example, the upper cover 160 may be made of a polyoxymethylene (POM) material that has low frictional resistance and high lubrication performance.

In an embodiment, the first portion-to-be-inserted 163 and the second portion-to-be-inserted 164 of the upper cover 160 may come into contact with the shaft 150 in a sliding manner, and the upper cover 160 may be made of the material having the high lubrication performance, thereby reducing frictional resistance between the shaft 150 and the body 120.

Therefore, the water dispenser 110 accommodated in the body 120 may be smoothly moved in the vertical direction, and the body 120, which does not come into direct contact with the shaft 150, may be made of various materials having low lubrication performance.

The water dispensing apparatus 100 may include a gap maintainer 260 that is coupled to an upper end of the shaft 150, is disposed on top of the upper cover 160, and maintains a gap between the plurality of shafts 150.

The gap maintainer 260 may have a plurality of grooves defined therein that are coupled to the upper ends of the plurality of shafts 150. The gap maintainer 260 may be coupled to the shaft 150 by inserting the upper end of the shaft 150 into the groove of the gap maintainer 260.

In an embodiment, the gap maintainer 260 may serve to allow the plurality of shafts 150 to maintain set locations thereof and gap therebetween. Therefore, when the body 120 moves in the vertical direction, the shafts 150 may maintain the set locations thereof and gap therebetween to allow the body 120 to move smoothly.

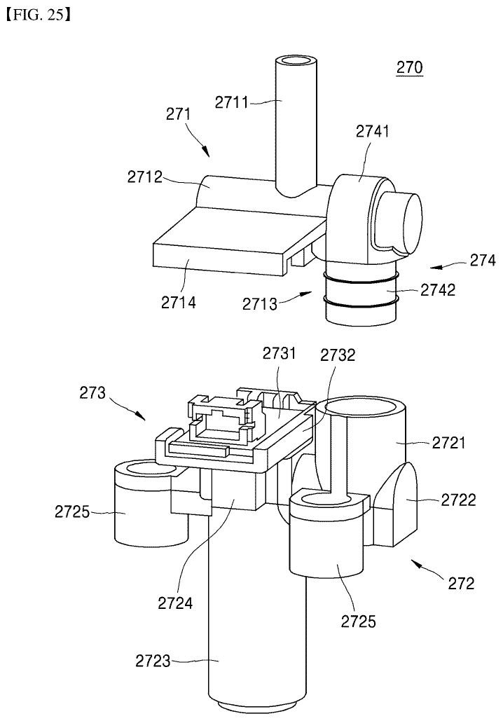

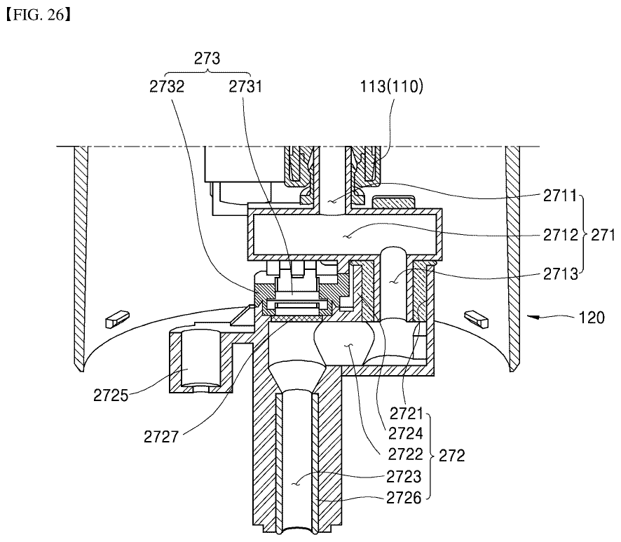

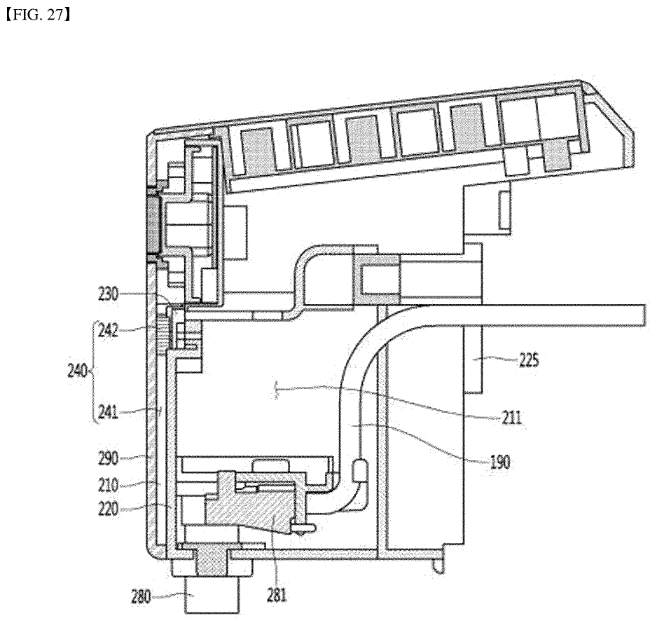

FIG. 24 is a diagram showing the sterilizer 270 according to an embodiment. For clear description, a flow channel connection portion 271 and a first substrate 273 are separated in FIG. 24. FIG. 25 is an exploded view showing the sterilizer 270 according to an embodiment. FIG. 26 is a cross-sectional view showing the sterilizer 270 and the body 120 coupled to each other.

The water dispensing apparatus 100 may include the sterilizer 270 mounted on the water dispenser 110. Water discharged from the water dispenser 110 may be sterilized by ultraviolet light while passing through the sterilizer 270 and discharged via the sixth flow channel 2723 of the second nozzle 272 to be contained in the cup.

The sterilizer 270 may include the flow channel connection portion 271, the second nozzle 272, the first substrate 273, and a first fastener 274. The flow channel connection portion 271 may be connected to the water dispenser 110, so that water may be introduced thereinto from the water dispenser 110.

The second nozzle 272 may be connected to the flow channel connection portion 271, and water for the user to drink may be discharged to the outside. Water sterilized while passing through the sterilizer 270 may be discharged to the outside via the sixth flow channel 2723 disposed in the second nozzle 272.

The sterilizer 270 may be turned on after the body 120 descends to a certain vertical level, and turned off before the water dispensing is completed and the body 120 ascends. The sterilizer 270 may be in the off state while the body 120 is ascending or descending.

The first substrate 273 may be disposed between the flow channel connection portion 271 and the second nozzle 272, and may be equipped with a light source that irradiates ultraviolet light toward the inside of the second nozzle 272. The light source of the first substrate 273 may irradiate ultraviolet light toward water to sterilize the same. The first fastener 274 may couple the flow channel connection portion 271 with the second nozzle 272.

The flow channel connection portion 271 may include a first flow channel 2711, a second flow channel 2712, a third flow channel 2713, and a first bracket 2714. The first flow channel 2711 may be connected to the water dispenser 110 and may receive water introduced thereinto. The first flow channel 2711 may allow water to flow downwardly of the water dispensing apparatus 100.

The second flow channel 2712 may be connected to the first flow channel 2711 and may allow water to flow in the lateral direction of the body 120. The third flow channel 2713 may be connected to the second flow channel 2712 and allow water to flow downwardly.

The first bracket 2714 may extend from the second flow channel 2712 and may allow the first substrate 273 to be seated thereon. The second flow channel 2712 and the third flow channel 2713 may allow water to flow bypassing a location where the first substrate 273 is disposed.

The second nozzle 272 may be connected to the flow channel connection portion 271, and water introduced from the flow channel connection portion 271 may be sterilized by being exposed to ultraviolet light irradiated from the first substrate 273 while passing through the second nozzle 272, and then discharged to the outside and filled in the cup.

The second nozzle 272 may include a fourth flow channel 2721, a fifth flow channel 2722, the sixth flow channel 2723, a second bracket 2724, and the second fastener 2725.

The fourth flow channel 2721 may have the third flow channel 2713 inserted thereinto. Therefore, the third flow channel 2713 and the fourth flow channel 2721 may be arranged such that at least partially overlap each other. The fourth flow channel 2721 may allow water to flow downward.

The fifth flow channel 2722 may be connected to the fourth flow channel 2721 and may allow water to flow in the lateral direction of the body 120. The fourth flow channel 2721 and the fifth flow channel 2722 may allow water to flow bypassing the location where the first substrate 273 is disposed.

The sixth flow channel 2723 may be connected to the fifth flow channel and discharge water to the outside. The sixth flow channel 2723 may allow water to flow downward.

The second bracket 2724 may be disposed at a location corresponding to the first bracket 2714 and allow the first substrate 273 to be seated thereon. The first substrate 273 may be stably mounted in the sterilizer 270 by being seated on the first bracket 2714 and the second bracket 2724.

The second fastener 2725 may extend outwardly of the second nozzle 272 and may couple the second nozzle 272 to the lower cover 190 of the water dispensing apparatus 100. The second fastener 2725 may be coupled to the fifth fastener 195 that is formed to protrude from the inner bottom surface of the lower cover.

The second fastener 2725 may include a plurality of second fasteners, and the number of fifth fasteners 195 may correspond to the number of second fasteners 2725. The second fastener 2725 and the fifth fastener 195 may be fastened to each other by the fastening mechanism, and as a result, the sterilizer 270 may be stably coupled to the lower cover 190.

Water introduced into the sterilizer 270 may bypass the first substrate 273 while passing through the second, third, fourth, and fifth flow channels, and may be sterilized by being exposed to ultraviolet light while passing through the fifth flow channel.

The second nozzle 272 may include a water dispense pipe 2726 disposed inside the sixth flow channel 2723 and made of stainless steel. Water may finally be discharged to the outside through the sixth flow channel 2723 and be filled in the cup.

Therefore, to ensure that water flows cohesively without scattering and to enhance linearity thereof when discharged, a surface of a flow channel inside the sixth flow channel 2723 needs to have surface roughness reduced.

Therefore, in an embodiment, the water dispense pipe 2726 made of the stainless steel is disposed inside the sixth flow channel 2723 where water for the user to drink is finally discharged from the water dispensing apparatus 100, so that discharged water may quietly go straight and be filled in the cup.

The first fastener 274 may include a ring 2741 and a packing 2742. The ring 2741 and the packing 2742 may be formed integrally. The ring 2741 may be mounted on the second flow channel 2712. The ring 2741 may be formed in a ring shape and may be fitted onto an outer circumferential surface of the second flow channel 2712.

The packing 2742 may extend from the ring 2741, surround the third flow channel 2713, and pack a gap between the third flow channel 2713 and the fourth flow channel 2721. When the ring 2741 is first fitted onto the second flow channel 2712 and the packing 2742 is then fitted into a flow channel of the fourth flow channel 2721, the third flow channel 2713 and the fourth flow channel 2721 may be arranged to overlap each other.

In this regard, the packing 2742 may be disposed between the third flow channel 2713 and the fourth flow channel 2721 and pack the gap between the third flow channel 2713 and the fourth flow channel 2721, thereby preventing water from leaking out through such a gap. The first fastener 274 may be made of, for example, a rubber material or a silicone material having good waterproof packing performance.

In an embodiment, the first fastener 274 may be used to easily connect the flow channel connection portion 271 with the second nozzle 272, and at the same time, the gap defined at a joint portion of the flow channel connection portion 271 and the second nozzle 272 may be effectively packed to effectively prevent the water leakage.

The first substrate 273 may be disposed between the second flow channel 2712 and the fifth flow channel 2722, which are disposed such that longitudinal directions thereof are directed in the lateral direction of the water dispensing apparatus 100, and may irradiate ultraviolet light toward water flowing in the fifth flow channel 2722.

The first substrate 273 may include a light source substrate 2731 and a first casing 2732. The light source substrate 2731 may be equipped with the light source that irradiates ultraviolet light. The light source may irradiate ultraviolet light in the downward direction of the water dispensing apparatus 100. The first casing 2732 may be seated on the first bracket 2714 and the second bracket 2724 and may support the light source substrate 2731. The light source substrate 2731 may be coupled to the first casing 2732.

The second nozzle 272 may include a window 2727 disposed in the fifth flow channel 2722 and made of a transparent material such that light generated from the first substrate 273 is irradiated to the sixth flow channel 2723 by passing through the fifth flow channel 2722.

The window 2727 may be formed in an upper portion of the fifth flow channel 2722. The window 2727 may be disposed on a portion of a wall forming the fifth flow channel 2722. The window 2727 may be disposed at a location facing the sixth flow channel 2723 in the upper portion of the fifth flow channel 2722. The light source substrate 2731 may be disposed at a location corresponding to the window 2727.

Therefore, ultraviolet light passing through the window 2727 may be irradiated onto water flowing through the fifth and sixth flow channels, spanning a portion of each. Water may be sterilized by being exposed to ultraviolet light while passing through the fifth and sixth flow channels.

In an embodiment, the sterilizer 270 disposed under the water dispenser 110 and connected to the water dispenser 110 may be disposed. Water may be sterilized by ultraviolet light while passing through the sterilizer 270, and be finally discharged to the outside. Because of such a structure, the hygiene of the water dispensing apparatus 100 may be improved.

Although the present disclosure has been described with reference to the drawings, the present disclosure is not limited to the embodiments disclosed herein and the drawings, and it is obvious that various modifications may be made by those skilled in the art within the scope of the technical idea of the present disclosure. In addition, even when the effects according to the configuration of the present disclosure were not explicitly described while describing the embodiments of the present disclosure, it is natural that the effects predictable by the corresponding configuration should also be acknowledged.

1. A liquid dispensing apparatus disposed in a water purifier, the liquid dispensing apparatus comprising:
a liquid dispenser configured to discharge liquid;
a body having a space defined inside to accommodate the liquid dispenser therein;
a driver configured to move the liquid dispenser;
a shaft configured to guide a movement of the body; and
an upper cover configured to be movable relative to the shaft.

2. The liquid dispensing apparatus of claim 1, wherein the liquid dispenser includes:
a liquid inlet configured to receive liquid introduced into the liquid dispenser;
a drainage fluidly connected to the liquid inlet and configured to discharge liquid outside of the liquid dispenser;
a first nozzle fluidly connected to the liquid inlet and configured to discharge liquid therethrough; and
a control valve configured to control opening and closing of the liquid inlet, the drainage, and the first nozzle.

3. The liquid dispensing apparatus of claim 2,
wherein the liquid dispenser includes a first mount extending from the control valve and configured to mount the liquid dispenser in the body, and
wherein the first mount includes:
a first region protruding from the control valve; and
a second region extending from the first region of the first mount and having a longitudinal direction parallel to a longitudinal direction of the body.

4. The liquid dispensing apparatus of claim 3, wherein the body includes:
a first body region protruding inwardly and in contact with a first surface of the second region of the first mount; and
a second body region disposed to be spaced apart from the first body region and configured to be in contact with a second surface opposite to the first surface of the second region of the first mount.

5. The liquid dispensing apparatus of claim 4,
wherein the upper cover includes a second mount configured to mount the liquid dispenser in the body, and
wherein the second mount includes:
a first mounting wall; and
a first hook disposed at an end of the first mounting wall and configured to be coupled to respective ends of the second region of the first mount and the second body region.

6. The liquid dispensing apparatus of claim 5, wherein the first hook has a pair of side edges that protrude to define a coupling groove therebetween, and respective ends of the second region of the first mount and the second body region are configured to be inserted into the coupling groove.

7. The liquid dispensing apparatus of claim 1, further comprising:
a light-emitter disposed in a lower portion of the body;
a second substrate disposed to be at least partially surrounded by the light-emitter and configured to irradiate an ultrasonic wave; and
a lower cover on which the light-emitter and the second substrate are seated, and configured to be mounted at a lower end of the body.

8. The liquid dispensing apparatus of claim 7,
wherein the light-emitter includes:
a third substrate including a light source configured to irradiate visible light;
a light diffuser that is optically connected to the light source included in the third substrate and is formed substantially in a ring shape; and
a light ring having the light diffuser disposed therein, and mounted in the body,
wherein the light ring is configured to outwardly irradiate light incident thereon after passing through the light diffuser.

9. The liquid dispensing apparatus of claim 8,
wherein the light ring includes:
a seating ring protruding from an inner surface of the light ring and configured to allow the light diffuser to be seated thereon; and
a first mounting protrusion protruding from the inner surface of the light ring and positioned above the seating ring,
wherein the first mounting protrusion is configured to mount the light diffuser on the seating ring.

10. The liquid dispensing apparatus of claim 8,
wherein the lower cover includes a second mounting protrusion protruding from an inner surface of the lower cover and configured to allow the light ring to be mounted thereon,
wherein the light ring includes a first mounting groove where the second mounting protrusion is mounted at a location corresponding to the second mounting protrusion.

11. The liquid dispensing apparatus of claim 7, wherein the lower cover includes:
a first hole defined substantially in a center region of the lower cover; and
a plurality of second holes provided around the first hole and configured to allow the ultrasonic wave irradiated from the second substrate to pass therethrough.

12. The liquid dispensing apparatus of claim 11, wherein the second substrate includes:
at least one ultrasonic transmitter disposed at a location corresponding to at least one of the plurality of second holes; and
at least one ultrasonic receiver disposed one or more remaining ones of the plurality of second holes, that differ from the at least one of the plurality of second holes where the ultrasonic transmitter is disposed.

13. The liquid dispensing apparatus of claim 8, further comprising:
a stopper movably disposed on the lower cover; and
a photo sensor that includes a photo detector configured to sense light and is configured to stop the movement of the body when the stopper moves upward and blocks the photo detector.

14. The liquid dispensing apparatus of claim 13,
wherein the photo sensor includes a third mount having a through-hole defined therein and positioned on the light ring, and
wherein the photo detector is formed integrally with the third mount and has a concave groove defined therein.

15. The liquid dispensing apparatus of claim 14, wherein the stopper includes:
a contact sensor protruding outwardly of the lower cover and configured to sense contact with a container to receive liquid from the liquid dispensing apparatus; and
a stopper protrusion formed integrally with the contact sensor, and configured to be positioned in the concave groove to suppress the photo detector from sensing light when the container comes into contact with the contact sensor and the stopper moves upward.

16. The liquid dispensing apparatus of claim 14,
wherein the lower cover includes a first mounting region where the stopper is mounted so as to be movable relative to the lower cover, and
wherein the light ring includes a pin configured to be inserted into the through-hole and a second mounting region where the third mount of the photo sensor is mounted.

17. The liquid dispensing apparatus of claim 7, wherein the lower cover includes a fastener configured to couple a sterilizer mounted on the liquid dispenser to the lower cover.

18. The liquid dispensing apparatus of claim 8,
wherein the body includes a third mounting protrusion that protrudes from an inner surface of the body and is configured to mount the light ring in the body, and
wherein the light ring includes a second mounting groove recessed from an outer surface of the light ring and configured to allow the third mounting protrusion to be mounted therein.

19. The liquid dispensing apparatus of claim 11, further comprising an extension provided in the first hole, and disposed to at least partially surround a section of the liquid dispenser from which liquid is dispensed,
wherein at least a portion of the extension protrudes downwardly of the lower cover.

20. The liquid dispensing apparatus of claim 1, further comprising a base coupled to the driver and including an accommodation hole through which the body moves,
wherein the shaft couples the upper cover to the base.
